(19) United States
(12) Patent Application Publication
(10) Pub. No.: US 2026/0368436 A1
(43) Pub. Date: Nov. 19, 2026

(54) Bootstrap Differentiation of a Persistent Cognitive Machine from an Initial Empty Cognitive Manifold State

(71) Applicant: AtomBeam Technologies Inc., Moraga, CA (US)

(72) Inventor: Brian Galvin, Silverdale, WA (US)

(21) Appl. No.: 19/575,257

(22) Filed: Mar. 23, 2026

Related U.S. Application Data
(63) Continuation-in-part of application No. 19/550,709, filed on Feb. 26, 2026.
Application No. 19/550,709 is a continuation-in-part of application No. 19/548,024, filed on Feb. 24, 2026.
Application No. 19/548,024 is a continuation-in-part of application No. 19/546,407, filed on Feb. 22, 2026.
Application No. 19/546,407 is a continuation-in-part of application No. 19/534,677, filed on Feb. 9, 2026, now Pat. No. 12,651,010.
(63) Continuation-in-part of application No. 19/321,168, filed on Sep. 5, 2025, now Pat. No. 12,585,882.
Application No. 19/321,168 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
(60) Provisional application No. 63/901,793, filed on Oct. 19, 2025.
(60) Provisional application No. 63/941,637, filed on Dec. 15, 2025.
(60) Provisional application No. 63/941,642, filed on Dec. 15, 2025.
(60) Provisional application No. 63/965,251, filed on Jan. 21, 2026.
(60) Provisional application No. 63/965,273, filed on Jan. 21, 2026.
(60) Provisional application No. 63/965,321, filed on Jan. 21, 2026.
(60) Provisional application No. 63/965,242, filed on Jan. 21, 2026.
(60) Provisional application No. 63/966,904, filed on Jan. 23, 2026.
(60) Provisional application No. 63/966,944, filed on Jan. 23, 2026.
(60) Provisional application No. 63/966,955, filed on Jan. 23, 2026.
(60) Provisional application No. 63/967,705, filed on Jan. 25, 2026.
(60) Provisional application No. 63/967,707, filed on Jan. 25, 2026.
(60) Provisional application No. 63/967,710, filed on Jan. 25, 2026.
(60) Provisional application No. 63/967,713, filed on Jan. 25, 2026.
(60) Provisional application No. 63/967,715, filed on Jan. 25, 2026.
(60) Provisional application No. 63/967,718, filed on Jan. 25, 2026.
(60) Provisional application No. 63/967,721, filed on Jan. 25, 2026.
(60) Provisional application No. 63/967,726, filed on Jan. 25, 2026.
(60) Provisional application No. 63/968,152, filed on Jan. 26, 2026.
(60) Provisional application No. 63/968,157, filed on Jan. 26, 2026.
(60) Provisional application No. 63/975,311, filed on Feb. 3, 2026.
(60) Provisional application No. 63/975,314, filed on Feb. 3, 2026.
(60) Provisional application No. 63/976,098, filed on Feb. 4, 2026.
(60) Provisional application No. 63/976,101, filed on Feb. 4, 2026.
(60) Provisional application No. 63/976,103, filed on Feb. 4, 2026.
(60) Provisional application No. 63/976,109, filed on Feb. 4, 2026.
(60) Provisional application No. 63/976,115, filed on Feb. 4, 2026.
(60) Provisional application No. 63/978,340, filed on Feb. 9, 2026.
(60) Provisional application No. 63/978,983, filed on Feb. 9, 2026.
(60) Provisional application No. 63/978,991, filed on Feb. 9, 2026.
(60) Provisional application No. 63/978,997, filed on Feb. 9, 2026.
(60) Provisional application No. 63/985,880, filed on Feb. 18, 2026.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method which bootstraps a persistent cognitive machine from an initial empty state in which a cognitive manifold has no curvature, no sector differentiation, no consolidated knowledge reservoirs, and no boundary structures. The system executes a differentiation sequence comprising a plurality of ordered steps: flooding the cognitive manifold with evidence to generate curvature; separating the generated curvature into semantic and epistemic types through rate separation; forming proto-reservoirs in regions of locally consistent evidence through differential relaxation; nucleating irreversible boundaries through a positive feedback process that constitutes the first irreversible structural commitment of the machine; crystallizing routing channels through boundary-mediated type matching; and achieving constitutive closure in which a three-timescale hierarchy governing active, boundary, and irreversible sectors emerges from an initial undifferentiated timescale. Upon constitutive closure, active computational load transitions from linear to logarithmic scaling with cumulative evidence.

### CROSS-REFERENCE TO RELATED APPLICATIONS

Priority is claimed in the application data sheet to the following patents or patent applications, each of which is expressly incorporated herein by reference in its entirety:

Ser. No. 19/550,709

Ser. No. 19/548,024

Ser. No. 19/546,407

Ser. No. 19/534,677

63/985,880

63/978,340

63/978,983

63/978,991

63/978,997

63/976,098

63/976,101

63/976,103

63/976,109

63/976,115

63/975,311

63/975,314

63/968,152

63/968,157

63/967,705

63/967,707

63/967,710

63/967,713

63/967,715

63/967,718

63/967,721

63/967,726

63/966,904

63/966,944

63/966,955

63/965,251

63/965,273

63/965,321

Ser. No. 19/321,168

Ser. No. 19/284,115

Ser. No. 19/051,193

### BACKGROUND OF THE INVENTION

### Field of the Art

The present invention relates to the field of artificial intelligence and cognitive computing, and more specifically to computer-implemented systems and methods for initializing a persistent geometric cognitive architecture from an empty state through a self-organizing, evidence-driven differentiation sequence.

### Discussion of the State of the Art

Existing computer-implemented cognitive systems suffer from a fundamental initialization problem that the art has not addressed: no system in the prior art is capable of bringing its own constitutive architecture into existence from a state of complete structural absence. Neural networks begin from randomly initialized weights whose organization is imposed by hand-designed layer topologies and training objectives rather than emerging from the system's own interaction with evidence. Knowledge graphs are populated by external curation and provide no mechanism for autonomous structural self-organization. Self-organizing maps produce spatial arrangements through competitive learning but do not distinguish between qualitatively different types of representational content, do not form irreversible structural commitments, and do not achieve a multi-timescale operational hierarchy. Memory-augmented neural networks address persistence through externally addressed storage modules whose organization is fixed at design time and does not evolve in response to evidence coherence. Classical cognitive architectures specify their declarative and procedural memory partitions, production rule systems, and processing hierarchies through designer configuration rather than allowing those structures to emerge from evidence-driven dynamics. Transformer-based language models reset their internal state between processing episodes and accumulate no permanent structural change across interactions. In each of these cases, the system arrives at its operational state through external imposition (via training, configuration, or design) rather than through a self-organizing process in which structural commitments are earned by the evidence and the architecture differentiates autonomously from an initially undifferentiated substrate.

What is needed is a system and method for initializing a persistent cognitive machine from a state of complete structural absence, such that the system's entire constitutive architecture —its sector decomposition, its consolidated knowledge reservoirs, its irreversible boundary structures, its typed routing channels, and its multi-timescale scheduling hierarchy—emerges autonomously from an initially empty cognitive manifold through a deterministic, self-terminating differentiation sequence driven by exposure to evidence.

### SUMMARY OF THE INVENTION

Accordingly, the inventor has conceived and reduced to practice a system and method which bootstraps a persistent cognitive machine from an initial empty state in which a cognitive manifold has no curvature, no sector differentiation, no consolidated knowledge reservoirs, and no boundary structures. The system executes a differentiation sequence comprising a plurality of ordered steps: flooding the cognitive manifold with evidence to generate curvature; separating the generated curvature into semantic and epistemic types through rate separation; forming proto-reservoirs in regions of locally consistent evidence through differential relaxation; nucleating irreversible boundaries through a positive feedback process that constitutes the first irreversible structural commitment of the machine; crystallizing routing channels through boundary-mediated type matching; and achieving constitutive closure in which a three-timescale hierarchy governing active, boundary, and irreversible sectors emerges from an initial undifferentiated timescale. Upon constitutive closure, active computational load transitions from linear to logarithmic scaling with cumulative evidence.

In a preferred embodiment, a computer system comprising at least one processor, a memory, and a plurality of programming instructions stored on a non-transitory computer-readable medium and configured to cause the at least one processor to: bootstrap a persistent cognitive machine from an initial empty state by executing a differentiation sequence on a cognitive manifold, wherein the cognitive manifold in the initial empty state has no curvature, no sector differentiation, no consolidated knowledge reservoirs, and no boundary structures, the differentiation sequence comprising: flooding the cognitive manifold with evidence to generate curvature on the cognitive manifold from the initial empty state; separating the generated curvature into semantic curvature and epistemic curvature through rate separation driven by distinct dynamical laws governing each curvature type; forming proto-reservoirs in regions of the cognitive manifold that receive locally consistent evidence through differential relaxation; nucleating irreversible boundaries through a positive feedback process that concentrates barrier energy at a boundary between a proto-reservoir interior region and an exterior region, wherein each nucleated boundary constitutes an irreversible constitutive commitment of the persistent cognitive machine; crystallizing routing channels that direct curvature flow through the nucleated boundaries into consolidated knowledge reservoirs; and achieving constitutive closure in which a three-timescale hierarchy governing an active sector, a boundary sector, and an irreversible sector of the cognitive manifold has emerged from an initial undifferentiated timescale of the initial empty state.

According to an aspect of an embodiment, the cognitive manifold in the initial empty state has a flat metric, a trivial connection, and an almost-complex structure that is formally allocated but dynamically inert with all coupling coefficients equal to zero, and wherein all nodes of the cognitive manifold carry a sector tag set to undifferentiated and all curvature arrays are initialized to zero.

According to an aspect of an embodiment, the cognitive manifold is represented as a weighted graph data structure comprising a plurality of nodes and edges, each node storing a metric tensor, a connection coefficient set, a curvature cache, a Nijenhuis tensor component, a sector tag, and scheduling flags, and each edge storing a parallel transport matrix, a curvature flow rate, and a type-matching score.

According to an aspect of an embodiment, the semantic curvature is a tensor-valued quantity computed from a Riemannian metric tensor and its derivatives representing semantic content density, the epistemic curvature is a 2-form-valued quantity computed from a connection on the cognitive manifold representing belief-justification coherence, and the rate separation occurs because semantic compression is governed by Ricci-flow dynamics operating on a first timescale and epistemic relaxation is governed by Yang-Mills dynamics operating on a second timescale shorter than the first timescale.

According to an aspect of an embodiment, transition from flooding to separating is detected by monitoring spatial variance of a Nijenhuis tensor across the cognitive manifold, wherein low spatial variance indicates uniform coupling strain during flooding and increasing spatial variance indicates heterogeneous type separation during separating.

According to an aspect of an embodiment, forming proto-reservoirs comprises identifying connected components of nodes whose local curvature energy falls below a detection threshold and assigning each identified component a stability score computed from a ratio of its local curvature energy to a mean curvature energy of its surrounding neighborhood, and wherein proto-reservoirs whose stability scores do not exceed a survival threshold are dissolved by perturbation from inconsistent evidence.

According to an aspect of an embodiment, the differentiation sequence exhibits a fast-slow-fast temporal pattern in which flooding and separating proceed relatively rapidly, forming proto-reservoirs and nucleating irreversible boundaries are rate-limited by a nucleation bottleneck requiring cooperative evidence coherence across a spatial region of the cognitive manifold, and crystallizing routing channels and achieving constitutive closure proceed relatively rapidly once the nucleated boundaries are established.

According to an aspect of an embodiment, the positive feedback process operates as a self-sustaining cycle in which increased proto-reservoir efficiency lowers interior curvature, the lowered interior curvature steepens a curvature gradient at the proto-reservoir perimeter, the steepened gradient concentrates barrier energy at perimeter nodes, and the concentrated barrier energy activates admission-control logic that further lowers interior curvature by preferentially admitting type-compatible curvature and reflecting type-incompatible curvature.

According to an aspect of an embodiment, nucleating irreversible boundaries further comprises re-tagging perimeter nodes of each proto-reservoir from undifferentiated sector membership to boundary sector membership, initializing barrier energy accumulators at the re-tagged perimeter nodes, re-tagging interior nodes of each proto-reservoir from undifferentiated sector membership to irreversible sector membership, activating admission-control logic at the boundary nodes, and logging each boundary nucleation event to a commitment ledger with a monotonically increasing commitment counter.

According to an aspect of an embodiment, crystallizing routing channels comprises computing a type-matching score between incoming curvature from the active sector and an absorptive profile of each reservoir in the irreversible sector at each boundary node, and routing curvature preferentially to boundaries with higher type-matching scores, wherein three forms of misrouting comprising laundering, congestion, and starvation decrease as type-matching scores stabilize.

According to an aspect of an embodiment, the differentiation sequence is monitored by a genesis controller module configured to monitor phase-diagnostic signals comprising curvature density, spatial variance of a Nijenhuis tensor, proto-reservoir count and stability, curvature gradient magnitudes, timescale ratios, and an inflationary parameter, to transition between steps of the differentiation sequence when phase-specific diagnostic thresholds are met, to adjust scheduling parameters based on a current step, and to log irreversible commitment events to a commitment ledger, and wherein the genesis controller module is distinct from a steady-state health monitor that becomes active only after constitutive closure.

According to an aspect of an embodiment, constitutive closure is detected by monitoring an inflationary parameter defined as a ratio of a constitutive absorption rate to a product of an evidence flux rate and an activation footprint coefficient, wherein the inflationary parameter is zero when the persistent cognitive machine has no absorptive capacity, increases toward unity as constitutive structure forms during the differentiation sequence, and reaches unity at constitutive closure, and wherein the persistent cognitive machine transitions from a linear scaling regime in which active node count grows proportionally with cumulative evidence to a logarithmic scaling regime in which active node count grows logarithmically with cumulative evidence upon constitutive closure.

According to an aspect of an embodiment, growth of the active computational load during the differentiation sequence is governed by a balance equation in which rate of change of active node count equals external evidence flux rate scaled by an inflationary gap, and wherein during proto-reservoir formation, boundary nucleation, and routing crystallization an inflationary acceleration is positive such that the differentiation sequence terminates in finite time without an external shutdown mechanism.

According to an aspect of an embodiment, the three-timescale hierarchy comprises a perturbation timescale governing high-frequency local curvature injection events in the active sector, a consolidation timescale governing intermediate-rate curvature type restructuring and compression in the active sector, and a reservoir timescale governing low-frequency irreversible curvature transfer through the boundary sector into the irreversible sector, wherein the perturbation timescale is shorter than the consolidation timescale, which is shorter than the reservoir timescale, and wherein this ordering is enforced by a scheduling architecture that gates slower operations on completion and stability of faster operations.

According to an aspect of an embodiment, a total curvature energy of the cognitive manifold satisfies a conservation law such that in the absence of new evidence from the evidence source the total curvature energy is redistributed among the active sector, the boundary sector, and the irreversible sector but is neither created nor destroyed, and wherein the conservation law is enforced by maintaining running sums of curvature energy in each sector and verifying that total curvature energy changes only by the amount of externally injected curvature.

According to an aspect of an embodiment, the system is further configured to, after constitutive closure, detect genuinely novel evidence by identifying simultaneous consolidation convergence failure in a localized region of the cognitive manifold and a local Nijenhuis tensor spike at the region of convergence failure, and in response allocate a genesis bubble comprising an isolated region of the cognitive manifold that locally re-enters the differentiation sequence constrained by boundary conditions from surrounding mature structure.

According to an aspect of an embodiment, the genesis bubble is not merged with the cognitive manifold until a local inflationary parameter of the genesis bubble reaches an integration window, and wherein the boundary conditions from the surrounding mature structure provide type axis alignment targets, evidence coherence information from adjacent domains, and pre-existing routing infrastructure at the genesis bubble boundary.

According to an aspect of an embodiment, merging the genesis bubble with the cognitive manifold comprises constructing a merger interface at a codimension-one region between the genesis bubble and the surrounding mature structure, the merger interface acquiring type transduction capacity to convert between curvature type conventions of the genesis bubble and the surrounding mature structure, and wherein constitutive mismatch at the merger interface is resolved across five independent components comprising type mismatch, routing mismatch, reservoir mismatch, timescale mismatch, and structural time mismatch.

According to an aspect of an embodiment, the evidence source comprises one or more of data inputs, sensor feeds, language model outputs, and outputs from an agent colony comprising a plurality of specialized agents configured to perform domain-specific operations on cached reasoning patterns, and wherein the agent colony provides domain-specific structured evidence flux to the cognitive manifold during the differentiation sequence.

According to an aspect of an embodiment, evidence is supplied to the cognitive manifold in a deliberate sequence that presents coherent evidence clusters prior to inconsistent evidence, increasing local evidence coherence during proto-reservoir formation and reducing a critical evidence volume required to achieve constitutive closure.

### BRIEF DESCRIPTION OF THE DRAWING FIGURES

FIG. 1 is a block diagram illustrating an exemplary system architecture of an epistemically conditioned persistent cognitive machine comprising interconnected subsystems arranged in a gated pipeline enforcing structural hallucination suppression.

FIG. 2 is a block diagram illustrating an epistemically conditioned manifold substrate maintaining a semantic metric, an almost-complex structure, a symplectic form, and an epistemic connection together implementing capacity constraints, admissibility boundaries, degeneracy regions, and structural gradients.

FIG. 3 is a block diagram illustrating a consolidation and irreversible suppression subsystem implementing reservoir formation, constraint projection, revision control, and asymmetric feedback mechanisms.

FIG. 4 is a flow diagram illustrating an exemplary epistemic admission control process performing structural compatibility evaluation, capacity-based admission, topological admissibility assessment, and epistemic curvature screening.

FIG. 5 is a flow diagram illustrating holonomy and epistemic phase monitoring during reasoning traversal, including phase accumulation, discontinuity detection, loop regime classification, and corroboration evaluation.

FIG. 6 is a flow diagram illustrating consolidation and irreversible suppression processes including reservoir readiness evaluation, consolidation gating across layers, non-invertible constraint projection, and localized revision.

FIG. 7 is a flow diagram illustrating coordinated operation of three structural hallucination suppression layers operating before, during, and after reasoning execution with cross-layer feedback interactions.

FIG. 8 is a flow diagram illustrating output generation and expression control conditioned on epistemic admissibility, including decoding, qualification, and suppression outcomes.

FIG. 9 is a flow diagram illustrating end-to-end data flow through the persistent cognitive system from input projection through admission, traversal, consolidation or suppression, output generation, and asynchronous geometric evolution.

FIG. 10 is a block diagram illustrating an exemplary system architecture for implementing the bootstrap differentiation sequence of a persistent cognitive machine.

FIG. 11 is a flow diagram illustrating an exemplary method for bootstrapping a persistent cognitive machine from an initial empty state through a sequential differentiation sequence, according to an embodiment.

FIG. 12 is a structural diagram providing a side-by-side comparison of the cognitive manifold in two states: the initial empty state prior to the commencement of bootstrap differentiation, and the mature PCM state following successful constitutive closure.

FIG. 13 is a flow diagram illustrating an exemplary boundary nucleation positive feedback cycle and the irreversible commitment sequence that follows from it.

FIG. 14 illustrates an exemplary computing environment on which an embodiment described herein may be implemented.

### DETAILED DESCRIPTION OF THE INVENTION

The inventor has conceived and reduced to practice a system and method which bootstraps a persistent cognitive machine from an initial empty state in which a cognitive manifold has no curvature, no sector differentiation, no consolidated knowledge reservoirs, and no boundary structures. The system executes a differentiation sequence comprising a plurality of ordered steps: flooding the cognitive manifold with evidence to generate curvature; separating the generated curvature into semantic and epistemic types through rate separation; forming proto-reservoirs in regions of locally consistent evidence through differential relaxation; nucleating irreversible boundaries through a positive feedback process that constitutes the first irreversible structural commitment of the machine; crystallizing routing channels through boundary-mediated type matching; and achieving constitutive closure in which a three-timescale hierarchy governing active, boundary, and irreversible sectors emerges from an initial undifferentiated timescale. Upon constitutive closure, active computational load transitions from linear to logarithmic scaling with cumulative evidence.

The present system is compatible with and extends any Persistent Cognitive Machine (PCM) architecture in which cognition is represented as structured traversal through a latent manifold that persists across interactions. Where a prior PCM architecture maintains holonomy descriptors encoding path-dependent experiential effects and manages homotopy class reasoning for suppression of inadmissible loop structures, the present system leverages those holonomy descriptors as instruments of epistemic monitoring and extends homotopy class management to handle epistemically conditioned constraint artifacts incorporating geometric information including curvature regime, capacity violation type, and phase drift signature in addition to homotopy class constraint patterns. Where a prior PCM architecture maintains irreversible reservoirs storing non-reconstructable constraint artifacts derived from inadmissible homotopy classes and propagates constraint patterns for read-only queries during class identification, the present system extends the reservoir infrastructure to additionally manage geometric reservoirs constituting consolidated knowledge as regions of the epistemically conditioned manifold satisfying phase flatness, barrier energy, and admission control conditions. The prior reservoir system handles information the system has learned to avoid; the geometric reservoirs of the present architecture additionally handle information the system has durably committed to. Both types of reservoir are irreversible in that projected constraint patterns cannot be reconstructed and consolidated geometric reservoirs resist perturbation with quantifiable stability bounds. The present system may be implemented incrementally by augmenting an existing PCM architecture with the epistemic conditioning structures and the three-layer hallucination suppression mechanisms disclosed herein, or may be implemented as a unified architecture incorporating all disclosed subsystems.

A computer system comprises one or more processors and non-transitory machine-readable storage media storing instructions that maintain a latent manifold serving as a cognitive substrate. The latent manifold represents cognitive states as locations and reasoning processes as trajectories through a geometric space. A semantic metric g defined on the manifold encodes semantic dissimilarity between cognitive states and determines geodesic distances and curvature. An almost-complex structure J defined on tangent spaces satisfies J squared equals negative identity and constrains admissible deformations of the manifold. A symplectic form ω is reconstructed from the semantic metric and the almost-complex structure according to a compatibility relation, for example ω(X, Y)=g(JX, Y), and satisfies dω=0. An epistemic line bundle L over the manifold is equipped with a U(1) connection A whose curvature F equals dA. The collection (g, J, ω, A) defines an epistemically conditioned manifold.

A semantic metric encodes semantic proximity between cognitive states. In some embodiments, further geometric structures are employed to encode evidential consistency and admissibility constraints in addition to semantic distance. A Riemannian manifold with metric g cannot distinguish between semantically similar but epistemically opposed propositions if they occupy nearby locations under g. The metric also permits smooth deformations that preserve distances without explicitly representing evidential relationships. Further, a Riemannian metric provides path length as a scalar but does not encode whether a reasoning path preserves justificatory integrity. The addition of J, ω, and A provides additional geometric structure that represents evidential relationships and path-level coherence properties not captured by semantic metric alone.

The epistemic line bundle L assigns to each manifold location a complex fiber representing an evidential state. In an embodiment, parallel transport of a section s along a path γ satisfies ΔA s=ds+A s=0, yielding s(γ(1))=exp(− [symbol] A) s(γ(0)). The magnitude of s is preserved under transport while its phase may rotate. The curvature F=dA measures failure of parallel transport around infinitesimal loops to return identity. In an embodiment, total curvature over a closed surface Σ satisfies (½π)∫Σ F ∈ [symbol] representing a first Chern number that quantizes enclosed epistemic curvature. The epistemic connection is independent of a Levi-Civita connection derived from the semantic metric and may assign different curvature values to regions that are metrically identical.

A discrete realization of the manifold may be implemented as a simplicial complex G=(V, E, F) comprising vertices V representing cognitive states, edges E representing semantic adjacencies, and faces F representing local neighborhoods. The semantic metric is represented by edge weights gij. The almost-complex structure is represented per vertex by a linear map Ji on an approximate tangent space. The symplectic form is computed on a face f=(i, j, k) as ωf=ω(eij, eik) using ω(X, Y)=g(JX, Y). The epistemic connection assigns to each oriented edge (i, j) a phase uij=exp(iθij) with θji=−θij. A discrete curvature value on a face f is computed, for example, as Ff=θij+θjk+θki modulo 2π. A Wilson loop for a closed path γ is computed as a product of edge phases or equivalently as Φ(γ)=Σ θ along γ. By a discrete Stokes relation, Φ(γ) equals a sum of Ff over faces enclosed by γ modulo 2π.

The architecture addresses two structurally distinct modes of hallucination, each requiring a dedicated suppression mechanism. A first mode, referred to herein as a regime hallucination, arises when a cognitive system attempts to consolidate or reason along a trajectory whose structural class is inadmissible within the epistemically conditioned manifold. In a regime hallucination, a trajectory as a whole violates epistemic constraints regardless of quality of individual steps. A regime hallucination may occur when a trajectory targets a forbidden region, exceeds symplectic capacity, or belongs to a homotopy class that has been projected into an irreversible reservoir. An epistemic admission control subsystem is directed primarily at suppressing regime hallucinations by evaluating structural admissibility before reasoning execution begins, thereby inhibiting instantiation of classes of trajectories that violate admissibility constraints.

A second mode, referred to herein as a drift hallucination, arises when a topologically admissible trajectory accumulates significant epistemic phase drift during traversal such that each individual step may be locally reasonable but cumulative effect is epistemic incoherence. In a drift hallucination, a trajectory passes all admission checks and does not violate any single constraint in isolation, but accumulated rotation of evidential grounding along a path renders final conclusion epistemically illegitimate. A holonomy and epistemic phase monitoring subsystem is directed primarily at suppressing drift hallucinations by tracking a path-dependent coherence quantity during traversal and detecting when cumulative phase drift exceeds a coherent regime. Distinction between regime hallucinations and drift hallucinations motivates architectural separation between pre-execution admission control and in-execution phase monitoring, because neither mechanism alone is sufficient to address both modes.

An input projection subsystem receives an external input or internally generated candidate state and maps the candidate state to a provisional location on the manifold using semantic attachment, such as harmonic extension from nearby landmark states. The provisional location is not immediately incorporated into active reasoning. An epistemic admission control subsystem evaluates admissibility of the provisional state prior to allowing formation of a reasoning trajectory. The admission control subsystem evaluates structural compatibility of an interpolated almost-complex structure by computing a residual such as rJ(p0)=max [symbol] ||(Πp0→ [symbol] ) * Jp0(Πp0→ [symbol] )−1−J [symbol] ||. The admission control subsystem evaluates symplectic capacity by computing a local capacity cω(i) =Σ|ωf| over incident faces and a capacity density ρω(i) as vertex count divided by cω(i), denying admission if ρ*ω exceeds threshold ρω. The admission control subsystem evaluates epistemic curvature by computing insertion curvature Fmax (p0) as maximum |Ff|over new faces and by performing micro-holonomy screening on short loops γ of bounded length Lmax, verifying |Φ(γ)|≤Φ*. The admission control subsystem evaluates topological admissibility within a reservoir-stratified state space defined by removing barrier neighborhoods associated with consolidated regions.

A reservoir-stratified state space M*⋄=M*\B(R) modifies topology of accessible state space. Removing barrier neighborhoods corresponding to consolidated regions changes a fundamental group of accessible state space so that homotopy classes become content-dependent. A trajectory contractible in an unconditioned manifold may become non-contractible in a stratified space if it must circumvent a reservoir boundary. Topological admissibility therefore depends on content of consolidated knowledge.

The admission control subsystem classifies outcomes including absorption, flagging, defect, or veto. Absorption incorporates a state fully into the manifold. Flagging permits participation in reasoning but excludes consolidation until stabilization. A defect records a boundary event when a provisional state near a reservoir boundary exhibits excessive curvature or phase drift. A veto prevents insertion when capacity constraints are violated.

A traversal and reasoning subsystem computes reasoning trajectories through the manifold from admitted states. During traversal, a holonomy and epistemic phase monitoring subsystem accumulates epistemic phase Φ(γ) along a trajectory. A closed loop γ is classified into regimes based on magnitude of Φ(γ). A coherent regime satisfies |Φ(γ)|≤Φ*. A drift regime satisfies Φ* <|Φ(γ)|<π and may require corroboration by an independent path γ′ reaching same conclusion, maintaining |Φ(γ′)|≤Φ*, and not deformable into γ within a reservoir-stratified state space. An inversion regime satisfies |Φ(γ)|≥π and blocks consolidation.

The holonomy and epistemic phase monitoring subsystem detects epistemic instability not only upon explicit loop closure but also during open-path traversal before any loop closure event occurs. A phase discontinuity is a structural inconsistency detected during traversal of a cognitive trajectory indicating loss of epistemic coherence prior to completion of a closed reasoning path. Phase discontinuities may arise from abrupt shifts in abstraction level unsupported by prior experience, convergence of incompatible holonomy descriptors at a single manifold location, attempted traversal across suppressed homotopy classes, or emergence of partial loop structures exhibiting self-inconsistency. The subsystem monitors whether transported holonomy descriptors from different source paths produce contradictory phase assessments at a current traversal location. When incompatible holonomy descriptors exert contradictory influence, resulting degradation of epistemic phase coherence is treated as a hallucination precursor rather than as an ambiguous but permissible reasoning state.

When epistemic phase instability is detected, the subsystem intervenes during reasoning execution without reliance on post-hoc filtering. Intervention may comprise interruption and termination of a trajectory, redirection toward an alternative admissible path, controlled backtracking to a stable manifold location, suspension pending clarification or additional input, or marking of a trajectory for subsequent irreversible suppression. Choice among intervention mechanisms may depend on severity of detected instability, proximity to consolidated regions, and availability of alternative admissible paths.

A consolidation and irreversible suppression subsystem manages formation and stability of irreversible reservoirs. A region U of the manifold becomes a reservoir when phase flatness sup|F|≤εR holds, barrier energy E∂U exceeds threshold E*, and admission control routes compatible states into U while excluding incompatible states. Barrier energy may be computed, for example, as E∂U=∫∂U (αF|F|\hat{ }2+αK|K∂|\hat{ }2+αω|dων|\hat{ }2) d μ. A consolidation transition is characterized as a geometric phase transition in which curvature collapses within U while boundary energy stabilizes. Consolidation exhibits hysteresis because conditions for destroying a reservoir require overcoming barrier energy and raising interior curvature above εR, which relaxation flow resists.

The consolidation and irreversible suppression subsystem classifies boundary events created by defect outcomes using phase defect magnitude and curvature decomposition into J-invariant and J-anti-invariant components. Corroborating evidence corresponds to small phase defect and curvature within threshold, resulting in absorption. Novelty corresponds to curvature predominantly compatible with J, indicating incomplete evidence and marking a growth candidate. Contradiction corresponds to curvature predominantly incompatible with J, indicating conflicting evidence and preventing extension. Ambiguous evidence corresponds to comparable curvature components and provisional attachment.

The subsystem monitors pre-reservoir regions exhibiting curvature decay under relaxation, decreasing phase variance over internal loops, increasing boundary energy, and decreasing structural compatibility residual associated with almost-complex structure. A consolidation transition occurs when interior curvature drops below flatness threshold, boundary energy exceeds barrier threshold, and boundary-aware admission control is activated. Consolidation is admitted only when topological admissibility, epistemic coherence or corroboration, and symplectic capacity constraints are concurrently satisfied.

A revision mechanism supports localized restructuring of consolidated regions when persistent contradictory boundary events accumulate beyond a revision threshold Φrev. Revision requires energy proportional to barrier energy, produces detectable boundary disturbances, and affects only region adjacent to accumulating contradiction. After restructuring, connection relaxation may restore flatness or permanently de-consolidate affected region.

A manifold evolution and execution subsystem updates geometric structures (g, J, ω, A) on separated timescales. Projection forcing operates on a fast timescale τP. A compression flow operates on an intermediate timescale τC and may minimize an extended energy including a Nijenhuis penalty term such as ∫||NJ||\hat{ }2d [symbol] . A connection relaxation flow operates on a slower timescale τR and minimizes curvature energy EA=Σf Ff\hat{ }2 through updates θij←θij−ηR ∂EA/∂θij. Timescale ordering τP [symbol] τC [symbol] τR reflects experience accumulation preceding geometric adjustment and geometric adjustment preceding epistemic consolidation.

Evolution may be characterized by a scaling vector S(t)=(Nsem(t), Cepi(t), Bcom(t), Sstr(t)) representing semantic complexity, epistemic curvature budget, boundary energy concentration, and structural regularity. Each component exhibits sublinear scaling, such as O(log E), with cumulative experience E. A learning readiness field Λ(b) may be defined on reservoir boundaries, for example Λ(b) =1/Egrowth(b, ε0), where Egrowth(b, ε)≈ε\hat{ }2(αω||∇νω||\hat{ }2+αJ||∇νJ||\hat{ }2+αF|F|\hat{ }2). The readiness field quantifies energetic cost of extending reservoir in direction ν and channels consolidation along symplectically favored directions.

Residual vulnerability of architecture is calibrational rather than structural. A hallucination may be admitted only when a trajectory is topologically admissible, epistemically coherent or independently corroborated, capacity-consistent, and content is nevertheless unjustified due to miscalibration of epistemic connection. Miscalibration may be surfaced over time as contradictory evidence accumulates.

In an embodiment, a consolidated irreversible reservoir satisfying phase flatness and barrier energy conditions exhibits quantifiable resistance to perturbation across three complementary dimensions of stability. A first dimension is semantic stability, in which admissible deformations of the semantic metric within the reservoir that preserve almost-Kähler compatibility and respect barrier energy at the boundary produce bounded geodesic distance changes within the reservoir interior. The bound on geodesic distance perturbation is controlled by two terms: a first term proportional to a product of the flatness threshold and a squared diameter of the reservoir, reflecting that flatter epistemic curvature within the reservoir constrains metric deformations through the compatibility relation linking the semantic metric, the almost-complex structure, and the symplectic form; and a second term that decays with increasing barrier energy, reflecting that higher barrier energy attenuates the influence of exterior perturbations before they propagate into the reservoir interior. A second dimension is epistemic stability, in which any modification to the epistemic connection within the reservoir requires energy proportional to the barrier energy and produces detectable boundary defects whose magnitude is bounded below by a ratio of the modification magnitude to a square root of the reservoir volume. This detectability bound ensures that the epistemic connection within a consolidated reservoir cannot be silently altered; any attempt to undermine evidential grounding within the reservoir produces a phase signature observable by the holonomy and epistemic phase monitoring subsystem. A third dimension is structural stability, in which symplectic capacity of the reservoir is preserved under admissible evolution. Under evolution that preserves the symplectic form, symplectic capacity is exactly invariant. Under approximate evolution within the almost-Kähler compatibility class, symplectic capacity changes are bounded by the metric perturbation bound from the first dimension, ensuring that consolidated cognitive structure cannot be compressed below its intrinsic symplectic capacity. Together, the three dimensions of stability ensure that consolidated knowledge resists semantic distortion, epistemic undermining, and structural compression, with each resistance quantified by computable bounds controlled by the flatness threshold and barrier energy of the reservoir.

In an embodiment, the evidential consistency function used to assign edge phase values in the epistemic connection comprises a plurality of component functions that are combined to produce a scalar consistency value for each pair of cognitive states connected by an edge in the discrete cognitive graph. A source consistency component measures agreement between evidential provenance of a candidate cognitive state and consolidated evidence at a neighboring state, evaluating whether methods, sources, or modalities that produced the candidate state are consistent with those that established the neighbor. A cross-modal corroboration component measures whether other cortices or processing modalities independently support an association between the candidate state and the neighbor. A temporal stability component measures whether a relationship between the candidate state and the neighbor is consistent over time or fluctuating. Each component takes values in a normalized range, with a maximum value indicating full consistency and a minimum value indicating maximal inconsistency. The component values are combined, for example by summation or weighted combination, to produce a composite evidential consistency value. An edge phase is then assigned by a monotone mapping from the composite consistency value to a phase interval, such that full consistency maps to zero phase indicating trivial epistemic transport along the edge, and zero consistency maps to a maximal phase value such as π indicating maximal evidential misalignment. In one embodiment, the mapping is linear, for example θ=π(1−φ) where φ is the composite consistency value and θ is the assigned edge phase. The decomposition of the evidential consistency function into identifiable components supports diagnostic classification of epistemic strain by enabling the system to attribute curvature contributions to specific evidential deficiencies, and the monotone mapping from consistency to phase preserves ordering of consistency levels in the geometric representation.

In an embodiment, assigning an almost-complex structure at a newly projected point involves interpolation from neighboring landmark structures followed by algebraic projection onto a constraint manifold of valid almost-complex structures. An interpolated pre-structure is computed as a weighted combination of almost-complex structures at landmark neighbors, where each landmark structure is transported to the projected point via discrete parallel transport along a shortest graph path and the transported structures are combined using weights determined by the semantic attachment step. The interpolated pre-structure will not, in general, satisfy the constraint that its square equals negative identity, because a convex combination of structures each satisfying the constraint does not itself satisfy the constraint. To obtain a valid almost-complex structure, the system performs an algebraic projection of the interpolated pre-structure onto the manifold of endomorphisms satisfying the squared-equals-negative-identity constraint. In one embodiment, the projection is performed by computing a singular value decomposition of the interpolated pre-structure and replacing the singular values with a canonical block-diagonal form corresponding to the constraint, while preserving the singular subspaces. The resulting structure is the nearest valid almost-complex structure to the interpolated pre-structure in a Frobenius norm sense and satisfies the constraint by construction. The projection is well-defined and unique when the interpolated pre-structure is not equidistant from multiple elements of the constraint manifold, which is the generic case. Other algebraic projection methods that produce a valid almost-complex structure nearest to the interpolated pre-structure under a suitable norm may be used. After projection, the structural compatibility residual is computed by comparing the assigned structure at the projected point against existing structures at its neighbors as seen through parallel transport, providing a discrete local approximation to a Nijenhuis tensor that measures local failure of integrability of the almost-complex structure.

In an embodiment, consolidated irreversible reservoirs exhibit geometric properties that distinguish them from frontier regions of the manifold undergoing active restructuring. As the connection relaxation flow drives epistemic curvature toward zero within a reservoir interior and the compression flow reduces structural compatibility residuals, the Nijenhuis tensor magnitude within the reservoir decays toward zero. When the Nijenhuis tensor is small, the almost-complex structure approaches integrability and the reservoir region becomes approximately Kähler rather than merely almost-Kähler. Approximate Kähler geometry provides additional rigidity beyond what the global almost-Kähler condition guarantees: in an approximately Kähler region, the metric is locally approximated by a single scalar potential, and the Riemannian, complex, and symplectic structures are locked together with greater constraint than in the general almost-Kähler case. This additional rigidity reinforces consolidation stability by further restricting the space of admissible deformations within the reservoir. The degree of Kähler approximation, as measured by the Nijenhuis tensor magnitude, thereby serves as a geometric correlate of epistemic maturity: frontier regions where the manifold is being actively restructured are merely almost-Kähler with significant Nijenhuis tensor, while consolidated regions where evidence is settled approach Kähler geometry as a consequence of relaxation dynamics. The system may track Nijenhuis tensor magnitude as one of the consolidation precursor metrics evaluated by pre-reservoir monitor.

In an embodiment, symplectic geometry of the manifold constrains directions along which consolidated reservoirs may extend when absorbing compatible new cognitive states at their boundaries. Extension of a reservoir boundary in a given direction requires that the symplectic form extends smoothly into the new territory without loss of non-degeneracy on newly created faces, that the almost-complex structure extends with bounded compatibility residual in the growth direction, and that epistemic curvature in the growth direction is within tolerance of the flatness threshold. Directions satisfying these conditions are symplectically favored for reservoir growth and correspond to regions where existing knowledge extends naturally into semantically and epistemically compatible territory. Directions failing any of these conditions are symplectically disfavored and correspond to regions where the geometric structures of the manifold are incompatible with smooth extension of the reservoir. The energetic cost of extending a reservoir by a given distance in a given direction is determined by a growth energy comprising contributions from variation of the symplectic form in the growth direction, variation of the almost-complex structure in the growth direction, and magnitude of epistemic curvature in the growth direction. The learning readiness field described at structural gradients of epistemically conditioned manifold substrate is computed as an inverse of this growth energy and quantifies which boundary directions support efficient knowledge acquisition and which require costly geometric restructuring. The symplectic contribution to growth energy implements a structural mechanism by which existing knowledge channels future learning: the symplectic geometry established by prior consolidation determines a landscape of readiness that biases subsequent consolidation toward compatible extensions of established understanding, rather than permitting uniform growth in all directions irrespective of geometric compatibility.

In an embodiment, the manifold evolution described with reference to manifold evolution and GPU execution subsystem comprises four distinct compression processes operating on the geometric structures of the epistemically conditioned manifold, each with characteristic dynamics. A semantic compression process operates through the compression flow on the semantic metric, merging redundant manifold vertices while preserving essential geodesic structure, and governs the growth of vertex count with cumulative experience. An epistemic compression process operates through the connection relaxation flow on the epistemic connection, reducing total squared epistemic curvature as evidence accumulates and the connection equilibrates, the steady-state curvature in a region being determined by a ratio of evidential noise variance to relaxation rate such that regions receiving consistent evidence converge to low curvature while regions receiving contradictory evidence retain elevated curvature. A commitment compression process operates on reservoir boundary structure as reservoirs form and mature, the transition from diffuse curvature gradients to sharp boundary concentration reducing the spatial extent of boundary neighborhoods while increasing barrier energy density. A structural compression process operates through the Nijenhuis penalty term of the extended geometric energy on the almost-complex and symplectic structures, driving the structural compatibility residual downward in stabilizing regions and reducing the Nijenhuis tensor magnitude toward zero in consolidated regions. Each compression process contributes a component to the scaling vector S(t). In an early regime of system operation, all four components grow with cumulative experience as the system acquires semantic content, builds epistemic structure, forms commitments, and regularizes geometry. In a mature regime, reservoir interiors become inexpensive to maintain because the epistemic connection is flat, the almost-complex structure is smooth, and the semantic metric is stable, while geometric complexity concentrates at frontier regions where new knowledge is being integrated and at reservoir boundaries where evidential transitions occur. Each component converges asymptotically to sublinear scaling with cumulative experience, reflecting a cognitive maturation process in which the system devotes decreasing effort to maintaining established knowledge and focuses geometric resources on the boundary between known and unknown territory.

In an embodiment, the epistemic connection maintained by epistemically conditioned manifold substrate is initialized from pairwise evidential consistency data among landmark states maintained by the input projection subsystem. At system initialization or after a spectral refresh of the landmark graph, an initial edge phase is assigned to each edge in the landmark graph by evaluating the evidential consistency function on the corresponding landmark pair and applying the monotone mapping from consistency to phase. For non-landmark vertices added subsequently through the input projection subsystem, edge phases are assigned during the projection process as part of the epistemic evaluation step of epistemic admission control. The initial connection is thus constructed entirely from pairwise evidential consistency data without requiring optimization or training. After initialization, the connection evolves under three mechanisms operating concurrently: evidence-driven updates that modify individual edge phases when new evidence alters the evidential consistency between connected vertices, the connection relaxation flow that redistributes epistemic curvature toward equilibrium by minimizing total squared curvature energy through gradient descent on edge phases, and projection impulses that introduce new edge phases as new vertices are admitted to the manifold. Because individual evidence-driven updates and projection impulses are local, modifying at most a bounded number of edge phases per event, the amortized cost of maintaining the epistemic connection is bounded independently of the total number of experiences. The relaxation flow operates asynchronously on a slow timescale and processes only edge phases stored on existing edges, with cost proportional to the number of edges and bounded by the logarithmic scaling of manifold size with cumulative experience.

In an embodiment, the epistemic connection further supports monitoring of discrete topological invariants that provide global consistency checks on the geometric state of the epistemically conditioned manifold. For a closed two-dimensional simplicial surface Σ embedded in the discrete cognitive graph, a discrete first Chern number is computed as a normalized sum of discrete epistemic curvature values over faces contained in Σ, for example c₁(Σ)=(½π)Σ_{f∈Σ} F_f modulo integer equivalence. Because the epistemic connection is represented by U(1) phases assigned to edges and curvature is computed as oriented face sums of those phases, the discrete first Chern number takes integer values under consistent gauge assignments. Monitoring of discrete first Chern numbers over representative closed surfaces provides a topological integrity check on the epistemic connection: continuous local updates to edge phases under evidence-driven updates or connection relaxation may redistribute curvature locally but cannot change the total curvature over a closed surface except by integer multiples of 2π. Detection of non-integer deviation beyond numerical tolerance indicates inconsistency in stored edge phase assignments or computational error. The discrete first Chern number thus functions as a global structural invariant constraining permissible evolution of the epistemic connection and reinforcing stability of consolidated reservoirs at a topological level distinct from local curvature thresholds.

In an embodiment, holonomy-based phase accumulation along closed reasoning loops is explicitly related to enclosed curvature through a discrete Stokes relation implemented on the simplicial complex. For a closed path γ bounding a two-chain of faces Σ, the accumulated epistemic phase Φ(γ) computed by summing edge phase values along γ equals, within numerical tolerance, the sum of discrete curvature values F_f over faces contained in Σ. This equality provides a structural link between path-level coherence diagnostics and region-level curvature distributions. Because curvature concentrations at reservoir boundaries contribute to loop phase accumulation for loops encircling those boundaries, the system may distinguish loops that traverse flat interior regions from loops that enclose high-curvature boundary layers, thereby enabling content-sensitive loop classification grounded in geometric structure rather than solely in path length or semantic similarity.

In an embodiment, geometric operations described herein are executed using parallel processing resources, including graphics processing units (GPUs) or other accelerators, to maintain real-time performance as cumulative experience increases. The epistemically conditioned manifold substrate stores vertex data, edge phase values, curvature fields, and compatibility residuals in contiguous memory layouts suitable for parallel access. Interpolation of almost-complex structures at newly projected vertices, computation of singular value decompositions for algebraic projection onto the constraint manifold J²=−Id, computation of insertion curvature over incident faces, and micro-holonomy screening over bounded-length loops are implemented as parallel kernels operating on bounded local neighborhoods of the discrete graph. Because each projection event modifies only a bounded number of vertices, edges, and faces, the amortized computational cost per projection is bounded independently of total manifold size under sublinear scaling of vertex count with cumulative experience. Connection relaxation flow updates edge phase values by performing parallel reductions over incident faces to compute curvature gradients, followed by gradient descent updates applied to edge phase arrays. Compression flow updates to semantic metric and almost-complex structure are likewise implemented as batched updates on local neighborhoods, with compatibility constraints enforced through projection operations that operate on fixed-size per-vertex data structures.

In an embodiment, a persistent execution graph is maintained for geometric update kernels such that projection impulses, compression flow steps, and connection relaxation steps are scheduled on separated logical timescales while sharing a common memory representation of the manifold. Fast-timescale projection impulses update local vertex, edge, and phase data structures immediately upon admission of new cognitive states. Intermediate-timescale compression flow iterations adjust semantic metric coordinates and reduce structural compatibility residuals, including Nijenhuis tensor magnitude, by minimizing an extended geometric energy functional subject to almost-Kähler compatibility constraints. Slow-timescale connection relaxation iterations update stored edge phase values to reduce total squared curvature energy. Because these flows operate on shared but logically partitioned data structures, updates to one geometric component propagate to others through explicit compatibility relations rather than implicit retraining or global recomputation. This structured execution model ensures that epistemic conditioning remains tightly coupled to geometric state evolution and that hallucination suppression mechanisms operate on continuously updated geometric observables.

In an embodiment, the discrete representation of admissibility boundaries and barrier neighborhoods is maintained as indexed edge and face sets stored in memory and updated upon reservoir formation or revision. Barrier edge bitmaps and associated geodesic distance fields are recomputed when a region transitions to consolidated status or undergoes revision, and are used by epistemic admission control subsystem and holonomy and epistemic phase monitoring subsystem to evaluate topological admissibility and corroboration non-deformability conditions. Because barrier sets are derived directly from geometric state, including phase flatness and boundary energy metrics, expansion or contraction of reservoirs alters the topological structure of the reservoir-stratified state space in a content-dependent manner. The discrete representation of barrier neighborhoods thereby implements a structural modification of the reachable state space that cannot be replicated by post hoc output filtering alone.

In an embodiment, numerical tolerances are defined for closedness of the symplectic form, integrality of discrete Chern numbers, and preservation of almost-Kähler compatibility under geometric evolution. Rather than requiring exact satisfaction of continuous differential-geometric identities, the system enforces these properties within computational tolerances determined by floating-point precision and discretization scale. Closedness of the symplectic form is verified by evaluating sums of face contributions around edges and ensuring that deviations remain below a stored tolerance. Approximate integrability of the almost-complex structure is measured by bounded Nijenhuis tensor magnitude. In this manner, discrete implementation faithfully approximates the intended geometric structures while remaining computationally tractable, and deviations beyond tolerance are treated as structural anomalies triggering corrective updates or diagnostic flags.

Through integration of semantic metric, almost-complex constraint, symplectic rigidity, and epistemic gauge structure, and through coupled projection, monitoring, consolidation, revision, and evolution processes, the system enforces hallucination resistance as a structural property of a persistent cognitive manifold.

In a non-limiting use case example, the system operates as a persistent cognitive assistant supporting scientific research over an extended engagement. A researcher queries the system regarding a relationship between two biological mechanisms that the system has encountered in separate bodies of prior experience. The input projection subsystem maps the query to a provisional location on the epistemically conditioned manifold near regions associated with both mechanisms.

The epistemic admission control subsystem evaluates the provisional location and determines that the local symplectic capacity can accommodate the new state and that the structural compatibility residual is within threshold, but that micro-holonomy screening on short loops connecting the two regions reveals significant phase accumulation, indicating that the evidential grounding relating the two mechanisms has not been established through prior experience. The admission control subsystem assigns a flag outcome, permitting the state to participate in reasoning at reduced commitment but excluding it from consolidation. The traversal and reasoning subsystem computes a trajectory connecting the two regions through intermediate abstractions.

During traversal, the holonomy and epistemic phase monitoring subsystem tracks the accumulated epistemic phase and detects that the trajectory enters a drift regime as it passes through a region of high epistemic curvature separating the two bodies of consolidated knowledge. Rather than terminating the trajectory, the system seeks corroboration by computing an independent trajectory reaching the same conclusion through a different intermediate region that traverses genuinely different epistemic territory and is not deformable into the original trajectory within the reservoir-stratified state space. If the independent trajectory maintains phase coherence within the coherent regime and reaches a cognitive state within the proximity threshold of the original conclusion, the conclusion is corroborated and may proceed toward output generation. If no corroborating trajectory can be found, the output generation and expression control subsystem produces a qualified response indicating that the proposed relationship is semantically plausible but not yet epistemically supported by the system's accumulated experience, and identifies the specific evidential gap as the region of high epistemic curvature between the two consolidated bodies of knowledge.

Over subsequent interactions, as the researcher provides additional evidence supporting or contradicting the proposed relationship, the connection relaxation flow incorporates that evidence into the epistemic connection, edge phases in the intermediate region adjust, and the epistemic curvature either decreases toward the flatness threshold enabling eventual consolidation or increases with predominantly contradictory curvature type confirming that the relationship is not supported. In this manner the system neither fabricates a confident but unsupported answer nor refuses to engage with the question, but instead provides a structurally grounded assessment of its own epistemic state and improves its capacity to address similar questions through accumulated experience.

The foregoing use case example is non-limiting in nature and illustrates one embodiment of the disclosed architecture. Many embodiments and use cases exist across diverse domains in which persistent reasoning, long-horizon memory, and high epistemic reliability are required. The systems and methods disclosed herein may be applied, without limitation, to long-running artificial assistants that accumulate experiential context across many interactions and must avoid confidently asserting unsupported claims even after prolonged operation, to scientific and technical reasoning systems in which hallucination may manifest as unsupported theoretical claims or invalid extrapolations, to legal reasoning and regulatory analysis systems in which hallucination may result in incorrect citations or fabricated authorities, to intelligence analysis and strategic decision-support systems in which hallucination may arise as unjustified confidence in speculative scenarios, to safety-critical and high-assurance systems including medical decision support and autonomous systems operating under regulatory constraints in which hallucination may pose unacceptable risk, to multimodal cognitive systems integrating visual, auditory, symbolic, or sensor-derived information in which cross-modal hallucination may arise from unsupported inferences drawn from partial or ambiguous data, and to federated or distributed deployments in which multiple persistent cognitive machines share abstract constraint representations through irreversible reservoirs without exposing underlying data or trajectories. Across these use cases, the technical effect of the invention is the structural prevention of hallucination through epistemic conditioning of the cognitive substrate itself, such that illegitimate reasoning regimes are excluded from execution, consolidation, and expression regardless of the particular inference engine, representation modality, or application domain.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “admissibility boundary” refers to a structural boundary within a latent manifold that separates regions in which reasoning trajectories are permitted from regions in which such trajectories are restricted or disallowed based on epistemic constraints.

As used herein, “almost-complex structure” refers to a tensor field on a latent manifold that assigns to each tangent space a linear map whose square equals negative identity, thereby defining canonical invariant two-dimensional planes and restricting admissible deformations of the manifold.

As used herein, “almost-Kähler compatibility” refers to a compatibility condition among a semantic metric, an almost-complex structure, and a symplectic form on a latent manifold, wherein the symplectic form is derived from the semantic metric and the almost-complex structure and remains closed under exterior differentiation.

As used herein, “barrier energy” refers to a computed energy associated with a boundary of a consolidated region, derived from one or more geometric quantities including epistemic curvature magnitude, extrinsic boundary curvature, or variation of a symplectic form across the boundary, the barrier energy quantifying resistance of the region to perturbation.

As used herein, “belief mass” refers to an abstract measure of representational commitment or compression associated with a region of a latent manifold.

As used herein, “boundary defect” refers to a localized event recorded at or near a reservoir boundary when a projected cognitive state exhibits epistemic curvature or phase inconsistency relative to an interior of a consolidated region.

As used herein, “capacity constraint” refers to a structural limitation on an amount of cognitive state density, belief mass, or representational compression that may be introduced into a region of a latent manifold without violating intrinsic geometric or epistemic limits of that region.

As used herein, “cognitive state” refers to a representational configuration corresponding to a location within a latent manifold and representing a hypothesis, belief, interpretation, or intermediate reasoning result.

As used herein, “cognitive trajectory” refers to a sequence of cognitive states corresponding to a path through a latent manifold, the path representing execution of a reasoning process.

As used herein, “coherence failure condition” refers to a detected condition during traversal of a cognitive trajectory indicating loss of epistemic coherence, including phase drift beyond a threshold, a phase discontinuity, or conflict among path-dependent descriptors.

As used herein, “configuration space” refers to a space of admissible geometric configurations of a latent manifold including at least a semantic metric, an almost-complex structure, a symplectic form, and an epistemic connection, subject to compatibility constraints.

As used herein, “consolidation stability” refers to a condition in which a consolidated region resists perturbations in semantic metric, epistemic connection, or symplectic structure within quantifiable bounds determined by curvature flatness and barrier energy.

As used herein, “consolidation transition” refers to a geometric phase transition in which a region of a latent manifold satisfies a flatness condition on epistemic curvature, exceeds a barrier energy threshold, and becomes classified as an irreversible reservoir.

As used herein, “degeneracy region” refers to a region of a latent manifold characterized by structural instability or elevated epistemic curvature such that reasoning within that region is unreliable or disallowed.

As used herein, “discrete epistemic curvature” refers to a curvature value computed on a discrete cognitive graph as a sum of edge phase values around a closed boundary path or simplicial face.

As used herein, “epistemic admissibility” refers to a structural determination, evaluated prior to or during reasoning execution, of whether a proposed cognitive state or trajectory is permitted to exist or be executed within an epistemically conditioned latent manifold.

As used herein, “epistemic coherence” refers to preservation of justificatory or evidential consistency along a cognitive trajectory, as measured by a path-dependent coherence quantity associated with transitions in the latent manifold.

As used herein, “epistemic conditioning” refers to embedding within a latent manifold structural constraints that govern admissibility, coherence, and capacity of reasoning trajectories independently of semantic similarity alone.

As used herein, “epistemic connection” refers to a geometric structure defined on transitions between cognitive states that assigns transition-specific coherence values and gives rise to a computable epistemic curvature over closed paths.

As used herein, “epistemic curvature” refers to a quantity computed from an epistemic connection over a closed path or local neighborhood of a latent manifold that measures cumulative evidential rotation or inconsistency.

As used herein, “epistemic line bundle” refers to a bundle structure over a latent manifold in which each manifold location carries an associated evidential state and in which parallel transport along manifold trajectories preserves magnitude while permitting phase rotation.

As used herein, “epistemic phase” refers to an accumulated path-dependent coherence quantity obtained by combining transition-specific coherence values along a cognitive trajectory.

As used herein, “evidential consistency function” refers to a function that assigns a scalar consistency value between two cognitive states based on one or more of source agreement, cross-modal corroboration, or temporal stability, the value being used to assign epistemic connection phases.

As used herein, “first Chern number” refers to a topological invariant computed from epistemic curvature over a closed two-dimensional surface in the latent manifold, representing a quantized measure of total epistemic curvature enclosed by the surface.

As used herein, “geometric phase transition” refers to a qualitative change in geometric structure of a latent manifold region characterized by collapse of epistemic curvature and stabilization of boundary energy, resulting in irreversible consolidation.

As used herein, “Gromov non-squeezing constraint” refers to a symplectic rigidity principle preventing compression of a region of a latent manifold below its intrinsic symplectic capacity.

As used herein, “hallucination” refers to execution or expression of a cognitive trajectory that is epistemically inadmissible within a conditioned latent manifold, regardless of semantic plausibility or syntactic fluency.

As used herein, “hallucination regime error” refers to operation of a cognitive system within a region or structural class of a latent manifold that violates epistemic admissibility constraints, such that resulting reasoning appears coherent but lacks structural legitimacy.

As used herein, “holonomy descriptor” refers to a path-dependent representation associated with a location in a latent manifold that encodes experiential distinctions arising from different prior trajectories that converge at that location.

As used herein, “irreversible reservoir” refers to a non-navigable storage structure configured to retain abstract constraint representations derived from epistemically inadmissible reasoning patterns or consolidated knowledge, or a consolidated region of a latent manifold satisfying phase flatness and barrier energy conditions, wherein contents of the reservoir influence future cognition through asymmetric feedback and are not modifiable by active reasoning.

As used herein, “J-anti-invariant component” refers to a portion of epistemic curvature incompatible with an almost-complex structure and associated with contradictory evidence.

As used herein, “J-invariant component” refers to a portion of epistemic curvature compatible with an almost-complex structure and associated with incomplete but internally consistent evidence.

As used herein, “latent manifold” refers to a geometric representational substrate in which cognitive states correspond to locations and reasoning processes correspond to trajectories through the space, the manifold encoding at least semantic relationships and, in certain embodiments, epistemic conditioning information.

As used herein, “learning readiness field” refers to a scalar field defined on a boundary of a consolidated region that quantifies energetic cost of extending the region in a given direction based on variation of geometric structures.

As used herein, “micro-holonomy screening” refers to evaluation of epistemic phase over short, closed loops in a discrete cognitive graph to detect local epistemic inconsistencies during projection.

As used herein, “Nijenhuis tensor” refers to a tensor measuring failure of integrability of an almost-complex structure and serving as a measure of structural strain in regions undergoing geometric restructuring.

As used herein, “non-invertible projection” refers to an operation that maps a reasoning trajectory or class of trajectories to an abstract constraint representation while discarding reconstructable details of the original trajectory, such that the original trajectory cannot be regenerated from the projected representation.

As used herein, “path-dependent coherence quantity” refers to a value accumulated along transitions of a cognitive trajectory that reflects preservation or loss of epistemic grounding during traversal.

As used herein, “phase discontinuity” refers to a structural inconsistency detected during traversal of a cognitive trajectory indicating abrupt change in epistemic phase inconsistent with accumulated path-dependent descriptors.

As used herein, “phase flatness” refers to a condition in which epistemic curvature magnitude within a region remains below a flatness threshold, such that parallel transport of epistemic state within the region is approximately path-independent.

As used herein, “reasoning trajectory” refers to a cognitive trajectory computed by a cognitive system to evaluate, infer, or synthesize information within a latent manifold.

As used herein, “reservoir boundary” refers to a boundary of a consolidated irreversible reservoir that separates an interior region of epistemic flatness from an exterior region of higher curvature or instability and that may impose energetic or topological constraints on traversal.

As used herein, “reservoir-stratified state space” refers to a manifold region obtained by removing barrier neighborhoods associated with irreversible reservoirs, such that homotopy classes in the resulting space depend on consolidated knowledge content.

As used herein, “scaling vector” refers to a multi-component measure tracking semantic complexity, epistemic curvature budget, boundary energy distribution, and structural regularity of a latent manifold as cumulative experience increases.

As used herein, “semantic metric” refers to a geometric structure defined on a latent manifold that encodes semantic dissimilarity between cognitive states and determines geodesic distances and local neighborhood relationships.

As used herein, “symplectic capacity” refers to a quantity derived from a symplectic form on a latent manifold that defines an intrinsic volumetric or structural limit on admissible compression or accumulation of cognitive states within a region.

As used herein, “symplectic form” refers to a non-degenerate, closed bilinear form compatible with a semantic metric and an almost-complex structure that encodes structural capacity and area-like measures on a latent manifold.

As used herein, “symplectic rigidity” refers to geometric constraints imposed by a symplectic form that restrict allowable deformations and prevent reduction of intrinsic capacity of a region.

As used herein, “trajectory class” refers to a grouping of cognitive trajectories sharing a common structural pattern or admissibility characteristic, including trajectories mapped to a shared abstract constraint representation in an irreversible reservoir.

As used herein, “Wilson loop” refers to a discrete computation of epistemic phase around a closed loop in a cognitive graph obtained by multiplying or summing edge phase values assigned by an epistemic connection.

### Conceptual Architecture of an Epistemically Conditioned Persistent Cognitive System

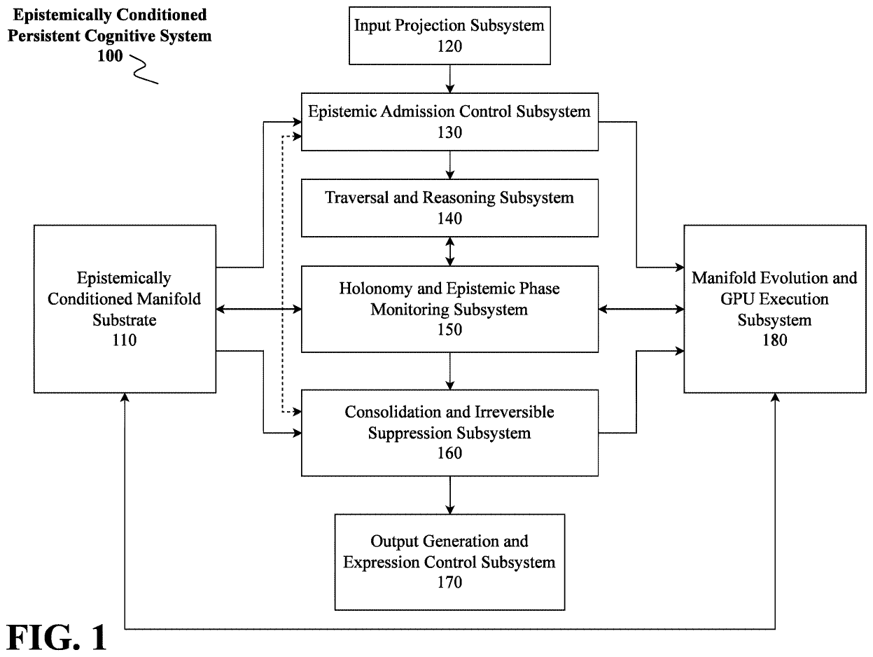

FIG. 1 is a block diagram illustrating an exemplary architecture of an epistemically conditioned persistent cognitive system 100, in an embodiment. A gated pipeline of subsystems enforces epistemic admissibility across a lifecycle of cognition, from initial projection of candidate cognitive states through output generation. An epistemically conditioned manifold substrate 110 and a manifold evolution and GPU execution subsystem 180 flank a central pipeline of six subsystems and provide, respectively, structured geometric state to the pipeline and continuous geometric evolution of manifold data structures stored in memory and operated on by one or more processors.

In an embodiment, each subsystem comprises processor-executable routines operating on structured data representations of vertices, edges, faces, edge phases, reservoir indices, and associated geometric observables maintained in memory. The architecture thereby alters internal computational state space of the machine such that inadmissible reasoning trajectories are structurally excluded from execution rather than filtered after generation.

An input projection subsystem 120 receives external inputs or internally generated latent representations and maps each to a provisional location on the manifold using semantic attachment such as harmonic extension from nearby landmark states. The provisional projection is represented as a candidate vertex insertion with associated geometric attributes and is not immediately incorporated into active traversal structures. Provisional projections are passed to an epistemic admission control subsystem 130, which operates as a first layer of a three-layer hallucination suppression architecture and evaluates each provisional projection prior to reasoning execution.

In an embodiment, epistemic admission control subsystem 130 applies structural checks derived from geometric state received from epistemically conditioned manifold substrate 110. These checks may include structural compatibility of an almost-complex structure through evaluation of a compatibility residual, symplectic capacity density computed from local face areas, topological admissibility within a reservoir-stratified state space determined from barrier edge sets, and epistemic curvature evaluated through insertion curvature and bounded micro-holonomy screening. When admission criteria are not satisfied, subsystem 130 inhibits instantiation of executable traversal structures corresponding to the provisional location, thereby preventing formation of a reasoning trajectory from that location. Projections satisfying admissibility criteria are admitted into active reasoning and forwarded as admitted states to a traversal and reasoning subsystem 140.

Traversal and reasoning subsystem 140 computes cognitive trajectories through the conditioned manifold from admitted initial states, subject to admissibility constraints encoded in manifold geometry. During traversal, a holonomy and epistemic phase monitoring subsystem 150, operating as a second layer of the three-layer hallucination suppression architecture, receives trajectory events from traversal and reasoning subsystem 140 and returns phase regime classifications and intervention signals. Holonomy and epistemic phase monitoring subsystem 150 accumulates epistemic phase along active trajectories using transition-specific phase values assigned by an epistemic connection maintained on manifold substrate 110 and classifies detected closed reasoning paths into coherent, drift, or inversion regimes based on magnitude of accumulated phase. When epistemic instability is detected, subsystem 150 may signal interruption, redirection, controlled backtracking, or suspension of traversal to traversal and reasoning subsystem 140. Trajectories marked as epistemically inadmissible, together with curvature type decomposition into components compatible and incompatible with the almost-complex structure, are forwarded to consolidation and irreversible suppression subsystem 160.

Consolidation and irreversible suppression subsystem 160 operates as a third layer of the three-layer hallucination suppression architecture and performs two complementary functions implemented through processor-executed reservoir management routines. For trajectories or regions approaching consolidation readiness, subsystem 160 evaluates phase flatness, boundary energy, and capacity admissibility and gates consolidation on concurrent satisfaction of epistemic admissibility at admission stage, epistemic coherence or corroboration at traversal stage, and capacity admissibility at consolidation stage. For trajectories determined to be epistemically inadmissible, subsystem 160 generates abstract constraint representations characterizing structural reasons for inadmissibility and projects those representations into non-navigable irreversible reservoirs through a non-invertible projection operator. The projection operator performs a many-to-one mapping that discards reconstructable trajectory details while preserving canonical constraint identifiers usable to detect structurally similar inadmissible patterns in subsequent reasoning. Reservoir contents are read-only with respect to active reasoning processes.

Cross-layer interactions between epistemic admission control subsystem 130 and consolidation and irreversible suppression subsystem 160 are depicted as dashed flows indicating feedback paths distinct from primary forward data flow. Consolidation and irreversible suppression subsystem 160 provides constraint feedback indices and barrier edge sets to epistemic admission control subsystem 130, enabling admission decisions to incorporate learned patterns of inadmissibility from previously projected constraints and to evaluate topological admissibility against current reservoir boundaries. In the opposite direction, epistemic admission control subsystem 130 forwards boundary defect events to consolidation and irreversible suppression subsystem 160 when a provisional projection near a reservoir boundary exhibits anomalous epistemic curvature or phase inconsistency. These cross-layer feedback paths support progressive tightening of admissibility constraints as reservoir structure matures and barrier sets expand.

An output generation and expression control subsystem 170 receives admissibility status signals from consolidation and irreversible suppression subsystem 160, phase regime classifications from holonomy and epistemic phase monitoring subsystem 150, and trajectory endpoints from traversal and reasoning subsystem 140. Decoding routines are conditioned on admissibility status flags such that decoding operations execute only when a reasoning trajectory remains epistemically admissible through admission and traversal. When no admissible trajectory supports a response, output may be suppressed, qualified, deferred, or accompanied by an indication of epistemic insufficiency. Decoder-level routines are structurally constrained by admissibility gating signals and do not override epistemic constraints imposed by conditioned manifold state.

Epistemically conditioned manifold substrate 110 maintains four geometric structures on a discrete simplicial complex stored in memory: a semantic metric g represented by weighted edges, an almost-complex structure J stored per vertex subject to J²=−Id, a symplectic form ω reconstructed from g and J according to a compatibility relation, and an epistemic connection A assigning transition-specific phase values whose discrete curvature F is independent of the semantic metric. Substrate 110 provides current geometric state to each layer of hallucination suppression architecture for use in admission evaluation, phase monitoring, consolidation gating, and topological stratification.

Manifold evolution and GPU execution subsystem 180 receives projection events from epistemic admission control subsystem 130, Chern number monitoring data from holonomy and epistemic phase monitoring subsystem 150, and consolidation and revision events from consolidation and irreversible suppression subsystem 160. Subsystem 180 governs coupled dynamics of all four geometric structures on separated timescales implemented as processor-executed flows, including a compression flow operating on an intermediate timescale and a connection relaxation flow operating on a slower timescale. Updated geometric structures are written back to manifold substrate 110, thereby conditioning subsequent cycles of pipeline against recurrence of previously identified inadmissible reasoning regimes.

In an embodiment, data flows through system 100 in a gated pipeline from ingestion to expression. An incoming cognitive state from an external or internal latent representation enters input projection subsystem 120, which produces a provisional projection on epistemically conditioned manifold substrate 110. The provisional projection passes to epistemic admission control subsystem 130 for pre-execution structural evaluation, and admitted states proceed to traversal and reasoning subsystem 140 for trajectory computation. During traversal, holonomy and epistemic phase monitoring subsystem 150 exchanges trajectory events and intervention signals with traversal and reasoning subsystem 140 in a bidirectional flow supporting real-time coherence monitoring. Trajectories reaching completion or requiring suppression flow to consolidation and irreversible suppression subsystem 160, which either commits structurally stable regions to irreversible reservoirs or projects abstract constraint representations into non-navigable reservoirs. Admissibility status propagates to output generation and expression control subsystem 170, which decodes admissible trajectory results into external representations such as natural language responses, symbolic structures, or executable actions directed to a user or downstream process. Concurrently, manifold evolution and GPU execution subsystem 180 updates geometric state on separated timescales, reinforcing structural admissibility constraints and progressively refining internal state space of the machine.

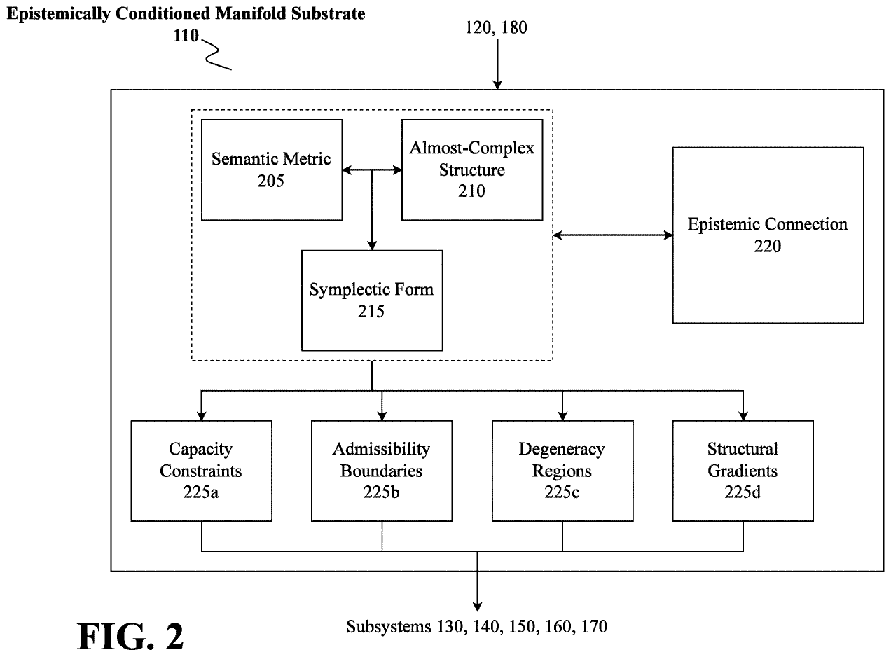

FIG. 2 is a block diagram illustrating exemplary architecture of an epistemically conditioned manifold substrate 110, in an embodiment. An epistemically conditioned manifold substrate 110 maintains four geometric data structures on a discrete simplicial complex G=(V, E, F) stored in memory and provides current geometric state to subsystems of a persistent cognitive system 100. Three sources supply updates to the geometric structures: an input projection subsystem 120 contributes new vertices, edges, faces, interpolated J-structures, and edge phases arising from projection events; a manifold evolution and GPU execution subsystem 180 contributes metric updates, J adjustments, and connection relaxation updates on separated timescales; and evidence-driven updates 201 contribute edge phase modifications to an epistemic connection as new evidence is incorporated into the system.

In an embodiment, a semantic metric 205 is represented by positive edge weights g_ij stored for edges of the simplicial complex, the weights encoding semantic dissimilarity between cognitive states represented as vertices. An almost-complex structure 210 is represented per vertex by a linear map J_i on an approximate tangent space, constrained such that J_i squared equals negative identity. The system enforces compatibility by constraining geometric updates so that deformations preserve, within tolerance, both semantic metric 205 and almost-complex structure 210. A J-Hermitian compatibility condition g(JX, JY)=g(X, Y) is maintained during metric updates by projecting updates onto a subspace satisfying the compatibility constraint.

A symplectic form 215 is reconstructed from semantic metric 205 and almost-complex structure 210 according to a compatibility relation ω(X, Y)=g(JX, Y). On the discrete complex, ω is evaluated on faces using edge vectors and local J assignments. Closedness dω=0 is verified and maintained within tolerance by enforcing discrete face-sum consistency conditions during update cycles. Together, semantic metric 205, almost-complex structure 210, and symplectic form 215 form an almost-Kähler-compatible triple maintained by processor-executed update routines, such that compatibility constraints are preserved during evolution of the manifold.

An epistemic connection 220 is implemented as a U(1) connection on an epistemic line bundle L over the manifold, assigning to each oriented edge a stored phase value u_ij=e\hat{ }{iθ_ij} encoding evidential consistency along that transition. A discrete epistemic curvature value F is computed on simplicial faces as a sum of edge phase values around each face. The curvature computation is independent of a Levi-Civita connection derived from semantic metric 205, enabling two regions identical under semantic metric 205 to exhibit different epistemic curvature values reflecting different levels of evidential support. Although epistemic connection 220 is geometrically independent of the almost-Kählertriple, it is operationally coupled to semantic metric 205, almost-complex structure 210, and symplectic form 215 through evolution dynamics, consolidation criteria, and hallucination diagnostics executed by other subsystems of persistent cognitive system 100.

The four geometric structures jointly establish epistemic conditioning of the manifold through four categories of computationally enforced constraint governing which cognitive operations may occur in which regions. Capacity constraints 225a are enforced by computing a local symplectic capacity from symplectic form 215 and deriving a capacity density as a ratio of local cognitive state count to computed symplectic capacity. When the capacity density exceeds a threshold, further insertion into the region is inhibited. In consolidated regions, compression routines are constrained so as not to reduce symplectic capacity below previously established levels, implementing a discrete analogue of a Gromov non-squeezing constraint through threshold enforcement rather than reliance on continuous deformation.

Admissibility boundaries 225b are implemented by computing reservoir barrier energy E∂U at boundaries of consolidated regions, where the barrier energy integrates contributions from epistemic curvature magnitude |F|² derived from epistemic connection 220, extrinsic boundary curvature |K∂|² derived from semantic metric 205, and symplectic normal variation |dω_ν|² derived from symplectic form 215. Barrier energy values are stored and compared against thresholds to determine whether transitions across boundary neighborhoods are permitted, thereby enforcing admissibility boundaries in discrete traversal routines.

Degeneracy regions 225c are identified when discrete epistemic curvature magnitude |F|computed from epistemic connection 220 exceeds a curvature threshold, indicating structural inconsistency or evidential strain. Regions exceeding the threshold are marked in memory as degeneracy regions, and traversal and consolidation routines consult these markings to inhibit reasoning operations or consolidation within those regions.

Structural gradients 225d are computed as a learning readiness field Λ(b) defined on reservoir boundaries. The learning readiness field is calculated from variation of almost-complex structure 210, symplectic form 215, and epistemic connection 220 in boundary neighborhoods, and quantifies energetic cost of extending a consolidated region in a given direction. Traversal and consolidation routines consult stored readiness values to bias growth and reasoning toward directions exhibiting lower computed extension cost, thereby implementing structural gradients as operational guidance rather than abstract geometric properties.

In an embodiment, capacity constraints 225a, admissibility boundaries 225b, degeneracy regions 225c, and structural gradients 225d are illustrative categories of epistemic conditioning implemented by epistemically conditioned manifold substrate 110 and are not exhaustive. Additional geometric state descriptors may be defined and maintained in memory based on combinations or higher-order functions of semantic metric 205, almost-complex structure 210, symplectic form 215, epistemic connection 220, holonomy descriptors, topological invariants, or evolution dynamics. Such additional descriptors may include, without limitation, regions characterized by distinct holonomy class constraints, phase stability regimes, structural integrability levels derived from a Nijenhuis tensor magnitude, relaxation-gradient distributions, quantized curvature aggregates associated with discrete topological invariants, or other computed observables that influence admissibility evaluation, traversal biasing, consolidation gating, or suppression decisions. Any such geometric state may be represented as stored fields, flags, indices, or scalar or tensor quantities derived from underlying geometric structures and may participate in constraint enforcement through threshold comparison, routing logic, or update rules executed by one or more processors. Accordingly, epistemic conditioning of the manifold is not limited to the specific constraint categories illustrated in FIG. 2, but encompasses any geometric or topological state representation derived from maintained manifold structures and used to regulate formation, traversal, consolidation, or expression of reasoning trajectories.

Geometric state comprising semantic metric 205, almost-complex structure 210, symplectic form 215, and epistemic connection 220, together with constraint information derived from capacity constraints 225a, admissibility boundaries 225b, degeneracy regions 225c, and structural gradients 225d, is provided by epistemically conditioned manifold substrate 110 to epistemic admission control subsystem 130, traversal and reasoning subsystem 140, holonomy and epistemic phase monitoring subsystem 150, consolidation and irreversible suppression subsystem 160, and output generation and expression control subsystem 170 for use in admission evaluation, phase monitoring, consolidation gating, topological stratification, and output conditioning respectively.

In an embodiment, data flows through epistemically conditioned manifold substrate 110 on separated timescales reflecting different rates of geometric change. On a fast timescale, input projection subsystem 120 supplies new vertices, edges, and faces that locally perturb semantic metric 205, together with interpolated J-structures incorporated into almost-complex structure 210 and edge phases incorporated into epistemic connection 220. After each perturbation, symplectic form 215 is reconstructed from updated semantic metric 205 and almost-complex structure 210 and discrete closedness conditions are re-verified.

On an intermediate timescale, manifold evolution and GPU execution subsystem 180 applies a compression flow that adjusts coordinates associated with semantic metric 205 and applies J adjustments that reduce a Nijenhuis tensor norm associated with almost-complex structure 210, thereby driving regions undergoing stabilization toward approximately Kähler-compatible configurations within computational tolerances.

On a slow timescale, manifold evolution and GPU execution subsystem 180 applies a connection relaxation flow that reduces total squared discrete epistemic curvature of epistemic connection 220 through incremental phase updates, while evidence-driven updates modify individual edge phases in response to new input. As geometric structures evolve under these separated flows, constraint information derived from capacity constraints 225a, admissibility boundaries 225b, degeneracy regions 225c, and structural gradients 225d is recomputed and updated in memory. Updated geometric state is then provided to downstream subsystems for use in subsequent cycles of a gated pipeline of persistent cognitive system 100, ensuring that admissibility constraints reflect accumulated experience and evolving manifold structure.

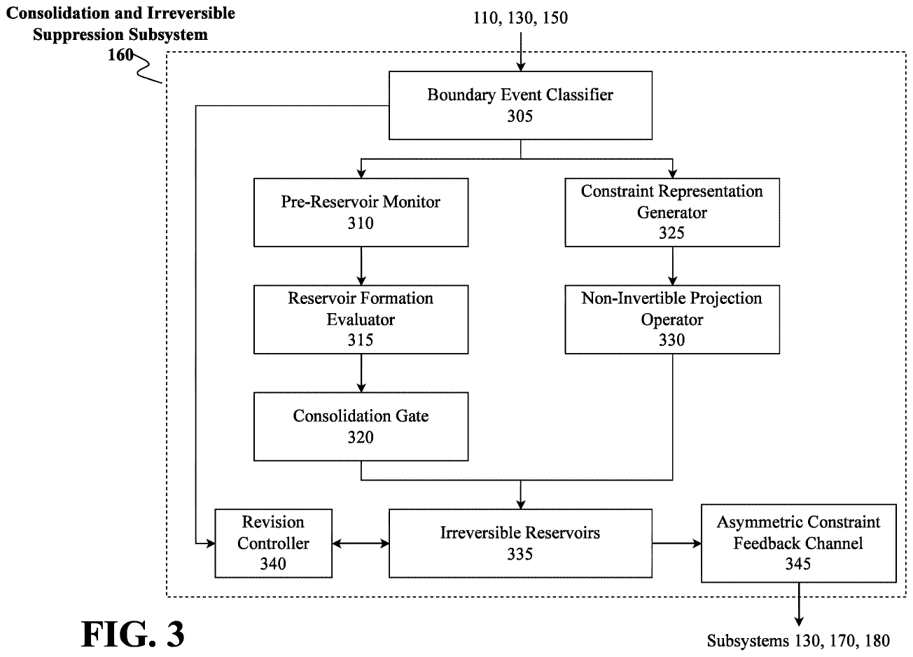

FIG. 3 is a block diagram illustrating exemplary architecture of a consolidation and irreversible suppression subsystem 160, in an embodiment. A consolidation and irreversible suppression subsystem 160 implements a third layer of a three-layer hallucination suppression architecture and performs two complementary functions arranged as parallel paths that converge at a shared reservoir structure. A consolidation path manages formation, stability, and revision of irreversible reservoirs constituting durable consolidated knowledge regions of an epistemically conditioned manifold. A suppression path constructs and projects abstract constraint representations of epistemically inadmissible reasoning patterns into non-navigable storage to support suppression of structurally similar patterns in subsequent reasoning. A consolidation and irreversible suppression subsystem 160 receives boundary defect events from an epistemic admission control subsystem 130, curvature type decomposition and trajectories marked for suppression from a holonomy and epistemic phase monitoring subsystem 150, and current geometric state from an epistemically conditioned manifold substrate 110.

Along the consolidation path, a boundary event classifier 305 receives boundary defect events together with curvature type decomposition into J-invariant and J-anti-invariant components from holonomy and epistemic phase monitoring subsystem 150. Boundary event classifier 305 assigns each event to one of four categories based on threshold comparisons and curvature ratios: corroborating evidence (B1), in which phase defect magnitude and curvature are within threshold and a corresponding point may be absorbed into a consolidated region; novelty (B2), in which curvature is predominantly J-invariant indicating incomplete but non-contradictory evidence and the point may be marked as a growth candidate; contradiction (B3), in which curvature is predominantly J-anti-invariant indicating conflicting evidence and the region is not extended; and ambiguous (B4), in which curvature components are comparable and the point is provisionally attached pending additional evidence. Corroborating and novelty classifications are forwarded to a pre-reservoir monitor 310 for continued processing along the consolidation path, while persistent contradiction classifications that accumulate beyond a revision threshold Φ_rev may trigger a reservoir revision controller 340.

A pre-reservoir monitor 310 tracks measurable precursors of consolidation readiness in regions approaching reservoir status. Tracked precursors may include, without limitation, a curvature decay rate reflecting reduction of epistemic curvature under a connection relaxation flow, phase coherence variance over representative internal loops, barrier energy growth as curvature contrast sharpens at region boundaries, and decay of a Nijenhuis tensor magnitude indicating approach toward approximately Kähler-compatible geometry within computational tolerances. When tracked precursors indicate that a region may be approaching consolidation readiness, pre-reservoir monitor 310 forwards the region to a reservoir formation evaluator 315 for assessment against formation conditions.

A reservoir formation evaluator 315 evaluates whether a candidate region satisfies three conditions for recognition as an irreversible reservoir: phase flatness in which epistemic curvature magnitude within the region is below a flatness threshold ε_R, barrier energy in which boundary energy E∂U computed from geometric properties of the region boundary exceeds a barrier threshold E*, and boundary-aware admission control in which compatible cognitive states are routed into the region while incompatible states are excluded. In various embodiments, boundary energy is computed and stored as a scalar or aggregate value derived from curvature magnitude, boundary curvature, and symplectic variation terms, and recognition as a reservoir is based on comparison of such stored values against predefined or adaptive thresholds. When the formation conditions are satisfied, the candidate region is forwarded to a consolidation gate 320.

A consolidation gate 320 evaluates whether concurrent satisfaction of constraints spanning all three layers of the hallucination suppression architecture has been achieved prior to permitting irreversible commitment. Consolidation may be permitted when a trajectory or region satisfies epistemic admissibility as evaluated by epistemic admission control subsystem 130, epistemic coherence or corroboration as evaluated by holonomy and epistemic phase monitoring subsystem 150, and capacity admissibility as evaluated by reservoir formation evaluator 315. When these conditions are concurrently satisfied, consolidation gate 320 permits the region to transition to an irreversible reservoir within irreversible reservoirs 335 as a consolidated knowledge region. Consolidation gate 320 may also provide admissibility status and consolidation gate decisions to output generation and expression control subsystem 170 for use in conditioning output generation on epistemic admissibility.

Along the suppression path, a constraint representation generator 325 receives trajectories marked for suppression by holonomy and epistemic phase monitoring subsystem 150 and constructs abstract constraint representations encoding structural reasons for inadmissibility, including, without limitation, violation type, severity indicators, scope information, and canonical identifiers supporting recognition of structurally similar patterns in subsequent reasoning. Constraint representation generator 325 may also receive persistent contradiction events from boundary event classifier 305 when accumulated B3 boundary defects indicate a pattern of epistemic inadmissibility associated with a particular region or trajectory class. Generated constraint representations are forwarded to a non-invertible projection operator 330.

A non-invertible projection operator 330 performs a many-to-one mapping that discards reconstructable details of inadmissible trajectories, including specific manifold locations, traversal sequences, and intermediate cognitive states, while preserving canonical constraint identifiers and structural pattern descriptors. Because the mapping is many-to-one, multiple distinct trajectories or trajectory classes may map to a common abstract constraint pattern, and original trajectories cannot be regenerated from projected representations using ordinary traversal or decoding mechanisms. Projected constraint representations are stored within irreversible reservoirs 335 as projected constraint artifacts that are not navigable by active reasoning processes.

Irreversible reservoirs 335 comprise two types of content that converge from the consolidation and suppression paths respectively. Consolidated knowledge regions are geometric reservoir regions of an epistemically conditioned manifold that satisfy phase flatness, barrier energy, and admission control conditions and that resist modification under routine traversal operations absent satisfaction of revision criteria. Projected constraint representations are abstract constraint artifacts derived from epistemically inadmissible trajectories and stored in non-navigable form. Both types are irreversible with respect to ordinary active reasoning operations in that projected constraint patterns are not reconstructable into executable cognitive trajectories and consolidated geometric reservoirs are not modified absent satisfaction of revision thresholds and corresponding boundary event conditions.

A reservoir revision controller 340 supports localized restructuring of consolidated knowledge regions when persistent contradictory boundary events of type B3 accumulate beyond revision threshold Φ_rev. Revision may be triggered by boundary event classifier 305 and may involve localized connection restructuring, temporary violation of phase flatness thresholds, and subsequent re-relaxation under connection relaxation flow. In various embodiments, revision requires boundary energy or contradiction magnitude to exceed stored threshold values and results in detectable changes in curvature or barrier energy metrics. Revision is localized to regions adjacent to accumulating contradiction and does not destabilize distant portions of reservoir structure.

An asymmetric constraint feedback channel 345 exposes read-only access to constraint information stored in irreversible reservoirs 335 for use by other subsystems. Feedback flows in one direction from irreversible reservoirs 335 to active cognition, and active reasoning processes do not modify reservoir contents through feedback channel 345. Asymmetric constraint feedback channel 345 may provide constraint feedback indices and barrier edge sets to epistemic admission control subsystem 130, supporting progressive tightening of admission thresholds and expansion of barrier topology as reservoir structure matures. Asymmetric constraint feedback channel 345 may also provide reservoir formation and revision events to manifold evolution and GPU execution subsystem 180 for incorporation into ongoing geometric evolution of manifold substrate 110.

In an embodiment, data flows through consolidation and irreversible suppression subsystem 160 along two parallel paths that converge at irreversible reservoirs 335. Along the consolidation path, boundary defect events arriving from epistemic admission control subsystem 130 are combined with curvature type decomposition from holonomy and epistemic phase monitoring subsystem 150 at boundary event classifier 305, which assigns each event to corroborating, novelty, contradiction, or ambiguous categories based on phase defect magnitude and ratio of J-invariant to J-anti-invariant curvature components. Corroborating and novelty classifications propagate to pre-reservoir monitor 310, which tracks curvature decay, phase coherence variance, barrier energy growth, and Nijenhuis decay in candidate regions and forwards regions approaching consolidation readiness to reservoir formation evaluator 315 for assessment against phase flatness, barrier energy, and admission control conditions. Regions satisfying formation conditions are forwarded to consolidation gate 320, which permits irreversible commitment only upon concurrent satisfaction of Layer 1 admissibility, Layer 2 coherence or corroboration, and Layer 3 capacity admissibility, and which provides resulting admissibility status and gate decisions to output generation and expression control subsystem 170. Along the suppression path, trajectories marked for suppression by holonomy and epistemic phase monitoring subsystem 150 enter constraint representation generator 325, which encodes structural reasons for inadmissibility into abstract constraint representations that are mapped through non-invertible projection operator 330, discarding reconstructable trajectory details, and deposited into irreversible reservoirs 335 as projected constraint artifacts. When contradiction classifications from boundary event classifier 305 accumulate beyond revision threshold Φ_rev, reservoir revision controller 340 initiates localized restructuring of affected consolidated knowledge regions within irreversible reservoirs 335. Downstream of both paths, asymmetric constraint feedback channel 345 provides read-only constraint indices and barrier edge sets from irreversible reservoirs 335 to epistemic admission control subsystem 130 and provides reservoir formation and revision events to manifold evolution and GPU execution subsystem 180, supporting progressive refinement of admission thresholds and geometric evolution of manifold substrate 110 as reservoir structure matures.

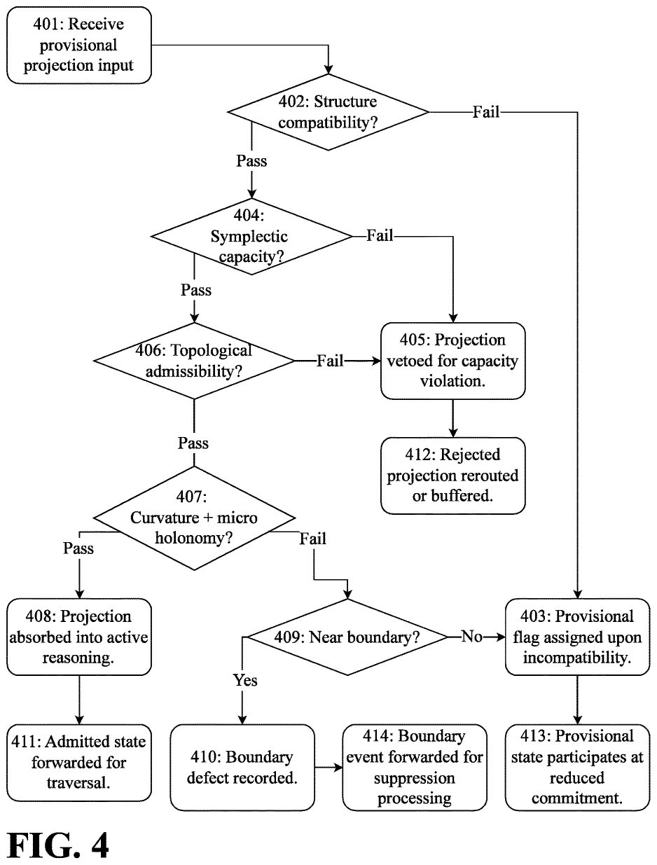

FIG. 4 is a flow diagram illustrating exemplary epistemic admission control evaluation within an epistemically conditioned persistent cognitive system, in an embodiment. Epistemic admission control subsystem 130 receives a provisional projection p₀ from input projection subsystem 120, where p₀ represents a candidate cognitive state mapped to a provisional location on epistemically conditioned manifold substrate 110 via semantic attachment 401. Epistemic admission control subsystem 130 evaluates structural compatibility of an interpolated almost-complex structure at the provisional location by computing a compatibility residual r_J measuring worst-case discrepancy between a transported almost-complex structure at p₀ and existing almost-complex structures at neighboring vertices, and compares the residual against a structural compatibility threshold r_J 402. When the structural compatibility residual exceeds the threshold, epistemic admission control subsystem 130 assigns a flag outcome based on exceeding the structural compatibility threshold and attaches the point as provisional with exclusion from consolidation until local geometry stabilizes 403. When the structural compatibility residual is within threshold, epistemic admission control subsystem 130 evaluates symplectic capacity density by computing a projected post-insertion capacity density ρ\hat{ }_ω at the provisional location from local symplectic face areas derived from symplectic form 215 and comparing the density against a capacity density threshold ρ_ω 404. When the projected capacity density exceeds the threshold, epistemic admission control subsystem 130 assigns a veto outcome rejecting the provisional projection from epistemically conditioned manifold substrate 110 405. When the capacity density is within threshold, epistemic admission control subsystem 130 evaluates topological admissibility of the provisional projection within a reservoir-stratified state space defined by removing barrier neighborhoods associated with consolidated regions maintained by consolidation and irreversible suppression subsystem 160, determining whether the provisional insertion and associated immediate transitions are reachable within the accessible region without crossing a barrier boundary absent admission-controlled passage 406. When topological admissibility is not satisfied, epistemic admission control subsystem 130 assigns a veto outcome at the same rejection node as when capacity density exceeds threshold 405. When topological admissibility is satisfied, epistemic admission control subsystem 130 evaluates epistemic curvature by computing insertion curvature F_max over new faces created by the proposed insertion and performing micro-holonomy screening over short closed loops of bounded length L_max passing through p₀ on the discrete cognitive graph, comparing insertion curvature against a curvature threshold F* and loop phase magnitudes against a phase drift threshold Φ* 407. When both insertion curvature and micro-holonomy screening are within their respective thresholds, epistemic admission control subsystem 130 assigns an absorb outcome admitting the provisional projection into active reasoning with full geometric assignments on epistemically conditioned manifold substrate 110 408. When insertion curvature exceeds the curvature threshold F* or micro-holonomy screening detects loop phase magnitude exceeding the phase drift threshold Φ*, epistemic admission control subsystem 130 evaluates whether the provisional location is near a reservoir boundary by comparing geodesic distance from p₀ to the nearest boundary of a consolidated region maintained by consolidation and irreversible suppression subsystem 160 against a boundary proximity threshold 409. When the provisional location is near a reservoir boundary and insertion curvature exceeds the curvature threshold F* or loop phase magnitude exceeds the phase drift threshold Φ*, epistemic admission control subsystem 130 assigns a defect outcome and records a boundary defect event at the nearest reservoir boundary 410. When the provisional location is not near a reservoir boundary and insertion curvature exceeds the curvature threshold F* or loop phase magnitude exceeds the phase drift threshold Φ*, epistemic admission control subsystem 130 assigns a flag outcome at the same provisional attachment node as when structural compatibility exceeds threshold 403. For absorb outcomes, epistemic admission control subsystem 130 forwards the admitted state with full geometric assignments to traversal and reasoning subsystem 140 for trajectory computation 411. For veto outcomes, the rejected projection is routed to an alternative neighborhood with available capacity or placed in a buffer for deferred integration after a subsequent compression cycle 412. For flag outcomes, the provisionally attached state participates in reasoning at reduced commitment while remaining excluded from consolidation 413. For defect outcomes, the recorded boundary event is forwarded to consolidation and irreversible suppression subsystem 160 for classification by boundary event classifier 305 414.

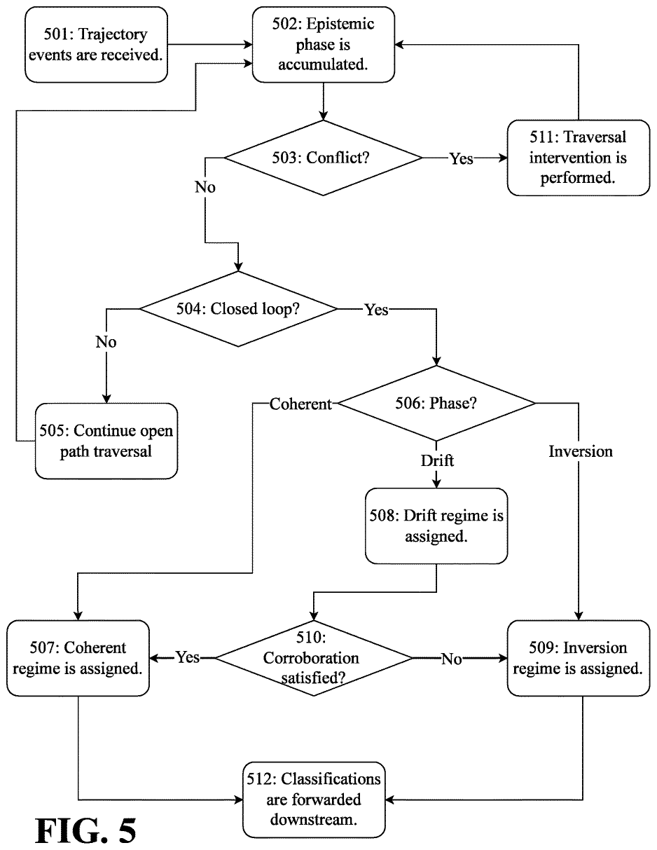

FIG. 5 is a flow diagram illustrating exemplary holonomy and epistemic phase monitoring within an epistemically conditioned persistent cognitive system, in an embodiment. Holonomy and epistemic phase monitoring subsystem 150 receives trajectory events from traversal and reasoning subsystem 140, the trajectory events comprising edge traversals, position updates, and contextual information associated with an active cognitive trajectory, the events being represented as updates to traversal data structures maintained in memory including a current vertex identifier, a visited-vertex index, and an accumulated phase variable 501. Holonomy and epistemic phase monitoring subsystem 150 computes and updates a stored epistemic phase variable Φ along the active trajectory by summing scalar phase values θ assigned by epistemic connection 220 of epistemically conditioned manifold substrate 110 to each edge traversed, the scalar summation being performed over stored edge phase values associated with oriented edges of a discrete cognitive graph, the accumulated phase representing total evidential drift along the reasoning path 502.

Holonomy and epistemic phase monitoring subsystem 150 computes one or more discontinuity metrics to determine whether a phase discontinuity or a conflict among holonomy descriptors applicable to a current traversal location exists, the discontinuity metrics including comparison of incremental phase gradient against a stored gradient threshold, evaluation of compatibility residuals between transported holonomy descriptors exceeding a descriptor conflict threshold, detection of traversal across a homotopy class identifier previously marked as suppressed in a constraint index, or detection of partial loop structures whose accumulated phase magnitude exceeds a bounded pre-closure threshold prior to loop completion 503. When no phase discontinuity metric exceeds its corresponding threshold and no holonomy conflict condition is satisfied, holonomy and epistemic phase monitoring subsystem 150 evaluates whether the active trajectory has revisited a previously visited vertex as determined by a lookup in a visited-vertex hash table maintained in memory, thereby detecting formation of a closed loop 504. When no closed loop is detected, holonomy and epistemic phase monitoring subsystem 150 continues open-path traversal monitoring by maintaining the accumulated phase variable and returns to accumulating epistemic phase along subsequent edges of the active trajectory 505.

When a closed loop γ is detected, holonomy and epistemic phase monitoring subsystem 150 computes a loop-specific epistemic phase Φ(γ) by summing stored edge phase values along the detected loop and classifies the loop into a phase regime by comparing an absolute value of Φ(γ) to a phase drift threshold Φ* and to π, the classification being recorded in a trajectory state structure 506. When the magnitude of Φ(γ) is at or below the phase drift threshold Φ*, holonomy and epistemic phase monitoring subsystem 150 assigns a coherent regime classification indicating that the reasoning loop maintained evidential coherence within tolerance and that consolidation of conclusions drawn along the loop is permitted 507. When the magnitude of Φ(γ) exceeds the phase drift threshold Φ* but remains below π, holonomy and epistemic phase monitoring subsystem 150 assigns a drift regime classification indicating that the loop accumulated significant epistemic drift and that consolidation is deferred pending corroboration by an independent path 508. When the magnitude of Φ(γ) equals or exceeds π, holonomy and epistemic phase monitoring subsystem 150 assigns an inversion regime classification indicating that evidential grounding at the conclusion is misaligned with grounding at the start beyond an inversion threshold, that consolidation is blocked, and that the trajectory is marked for subsequent irreversible suppression by consolidation and irreversible suppression subsystem 160 through setting of a suppression flag in a trajectory control structure 509.

For a trajectory classified in the drift regime, holonomy and epistemic phase monitoring subsystem 150 evaluates whether an independent corroborating path γ′ supplied by traversal and reasoning subsystem 140 satisfies three computationally verifiable conditions: γ′ terminates at a cognitive state whose geodesic distance under semantic metric g is within a proximity threshold of the conclusion reached by the original trajectory; γ′ maintains accumulated epistemic phase within the coherent regime as determined by comparison against phase drift threshold Φ*; and γ′ is not deformable into the original trajectory within the reservoir-stratified state space as determined by comparison of homotopy class identifiers or by evaluating reachability equivalence under barrier edge constraints supplied by consolidation and irreversible suppression subsystem 160 510.

When a phase discontinuity metric exceeds its threshold or a holonomy conflict condition is detected at step 503, holonomy and epistemic phase monitoring subsystem 150 modifies traversal control structures of traversal and reasoning subsystem 140 during reasoning execution, the modification comprising at least one of terminating a traversal stack entry, re-routing traversal through an alternative admissible edge selected from a priority queue excluding edges associated with suppressed homotopy classes or degeneracy regions, performing controlled backtracking to a previously recorded coherent vertex, suspending traversal pending additional input, or marking the trajectory for subsequent irreversible suppression, and after such intervention the redirected or resumed trajectory returns to epistemic phase accumulation with the accumulated phase variable updated in accordance with the modified traversal state 511.

Holonomy and epistemic phase monitoring subsystem 150 forwards phase regime classifications comprising coherent, drift, or inversion designations together with curvature type decomposition into J-invariant and J-anti-invariant components computed from discrete epistemic curvature values associated with faces traversed by the trajectory to consolidation and irreversible suppression subsystem 160, the forwarded data being used for boundary event classification, consolidation gating, and generation of abstract constraint representations for non-invertible projection 512.

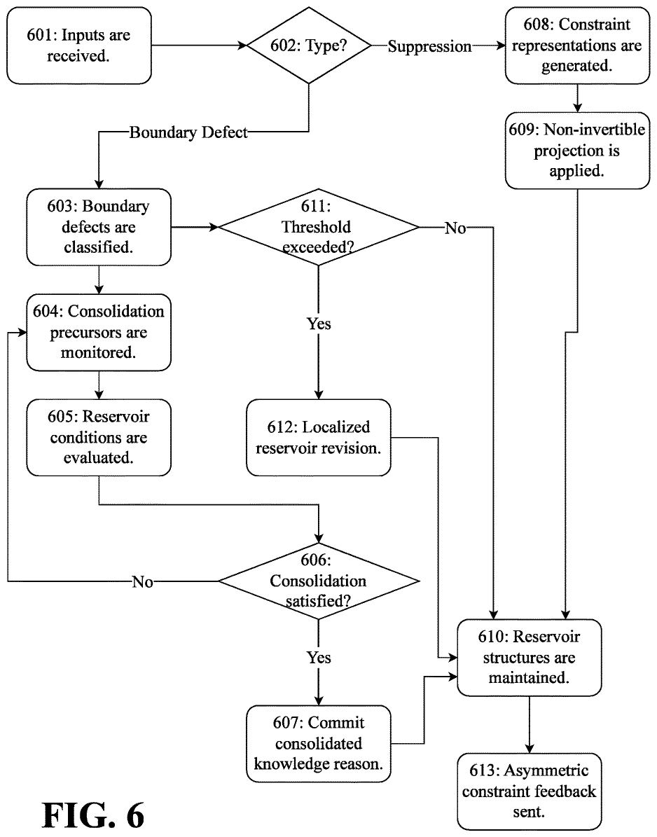

FIG. 6 is a flow diagram illustrating exemplary consolidation and irreversible suppression within an epistemically conditioned persistent cognitive system, in an embodiment. Consolidation and irreversible suppression subsystem 160 receives boundary defect events from epistemic admission control subsystem 130, trajectories marked for suppression from holonomy and epistemic phase monitoring subsystem 150, and current geometric state from epistemically conditioned manifold substrate 110, the received inputs being represented as structured data records stored in memory including defect metrics, trajectory identifiers, and geometric observables 601. Consolidation and irreversible suppression subsystem 160 partitions the received inputs according to event classification, directing boundary defect event records to a consolidation processing stream and directing trajectory records marked for suppression to a suppression processing stream based on stored event-type identifiers 602.

Along the consolidation processing stream, boundary event classifier 305 computes a defect classification for each boundary defect event by comparing phase defect magnitude against a phase defect threshold and by evaluating a curvature type decomposition into J-invariant and J-anti-invariant components received from holonomy and epistemic phase monitoring subsystem 150, assigning each event to one of four stored classification codes corresponding to corroborating evidence B1, novelty B2, contradiction B3, or ambiguous B4 603. When a boundary defect is classified as corroborating evidence B1 or novelty B2, pre-reservoir monitor 310 computes and tracks measurable consolidation precursor metrics in candidate regions approaching reservoir readiness, the metrics including a curvature decay rate computed over successive connection relaxation iterations, a phase coherence variance computed over representative internal loops within a bounded geodesic neighborhood, a barrier energy growth rate computed from stored boundary energy values, and a Nijenhuis tensor magnitude decay computed from structural compatibility residuals, each metric being compared against a corresponding readiness threshold or convergence bound stored in memory 604.

Reservoir formation evaluator 315 evaluates whether a candidate region satisfies three computationally verifiable conditions for recognition as an irreversible reservoir: phase flatness in which stored epistemic curvature magnitudes for all vertices and faces within the region are below flatness threshold ε_R; barrier energy in which boundary energy E∂U computed from curvature magnitude, extrinsic boundary curvature, and symplectic normal variation exceeds barrier threshold E*; and boundary-aware admission control in which admission control outcome codes for new insertions within a boundary neighborhood indicate consistent absorption of compatible states and exclusion of incompatible states according to stored admissibility criteria 605. Consolidation gate 320 computes a logical conjunction of constraint flags corresponding to three layers of the hallucination suppression architecture, requiring (i) epistemic admissibility flag set by epistemic admission control subsystem 130, (ii) epistemic coherence or corroboration flag set by holonomy and epistemic phase monitoring subsystem 150, and (iii) capacity admissibility flag set by reservoir formation evaluator 315, and when the logical conjunction is false consolidation gate 320 returns the candidate region to pre-reservoir monitor 310 for continued precursor monitoring and geometric evolution under relaxation dynamics 606. When the logical conjunction is true, consolidation gate 320 permits the candidate region to transition to an irreversible reservoir within irreversible reservoirs 335 as a consolidated knowledge region, storing region identifiers, boundary indices, and stability metrics reflecting phase flatness, barrier energy, and admission control stability conditions 607.

Along the suppression processing stream, constraint representation generator 325 receives trajectory records marked for suppression and constructs abstract constraint representations by extracting structural violation features from the trajectory record, including violation type, severity indicators derived from phase magnitude or curvature metrics, contextual scope identifiers, and canonical pattern identifiers generated through normalization or hashing procedures supporting recognition of structurally similar patterns in subsequent reasoning 608. Non-invertible projection operator 330 applies a many-to-one canonicalization mapping that discards reconstructable trajectory details including specific manifold coordinates, traversal sequences, and intermediate cognitive state identifiers, while preserving canonical constraint identifiers and structural pattern descriptors, the mapping being implemented such that no inverse mapping from stored constraint representation to original trajectory record exists within active traversal data structures 609.

Irreversible reservoirs 335 maintain both consolidated knowledge regions committed along the consolidation processing stream and projected constraint artifacts deposited along the suppression processing stream, where consolidated knowledge regions are represented as indexed geometric subregions of the manifold satisfying stored phase flatness and barrier energy conditions, and projected constraint artifacts are stored as non-navigable abstract constraint records not reconstructable into executable cognitive trajectories or traversal sequences 610. When a boundary defect is classified as contradiction B3 at step 603, consolidation and irreversible suppression subsystem 160 computes an accumulated contradiction magnitude for the associated boundary region by summing or integrating stored J-anti-invariant curvature magnitudes or phase defect values over successive B3 events within a bounded boundary neighborhood and compares the accumulated magnitude against revision threshold Φ_rev 611. When accumulated contradiction magnitude exceeds revision threshold Φ_rev, reservoir revision controller 340 initiates localized restructuring of an affected consolidated knowledge region within irreversible reservoirs 335, the restructuring being limited to vertices and faces within a bounded geodesic radius of the boundary defect cluster, and comprising localized connection parameter updates, temporary violation of phase flatness constraints, and subsequent re-application of connection relaxation flow to restore curvature below flatness threshold where consistent, such restructuring being confined to the affected region without destabilizing distant reservoir regions 612.

Asymmetric constraint feedback channel 345 exposes read-only constraint indices and barrier edge bitmaps derived from irreversible reservoirs 335 for query by epistemic admission control subsystem 130, enabling admission threshold comparisons and topological admissibility evaluation using updated barrier edge sets, and provides reservoir formation and revision event notifications to manifold evolution and GPU execution subsystem 180 for incorporation into ongoing geometric evolution and threshold recalibration of epistemically conditioned manifold substrate 110, wherein active reasoning processes do not modify contents of irreversible reservoirs through the feedback channel 613.

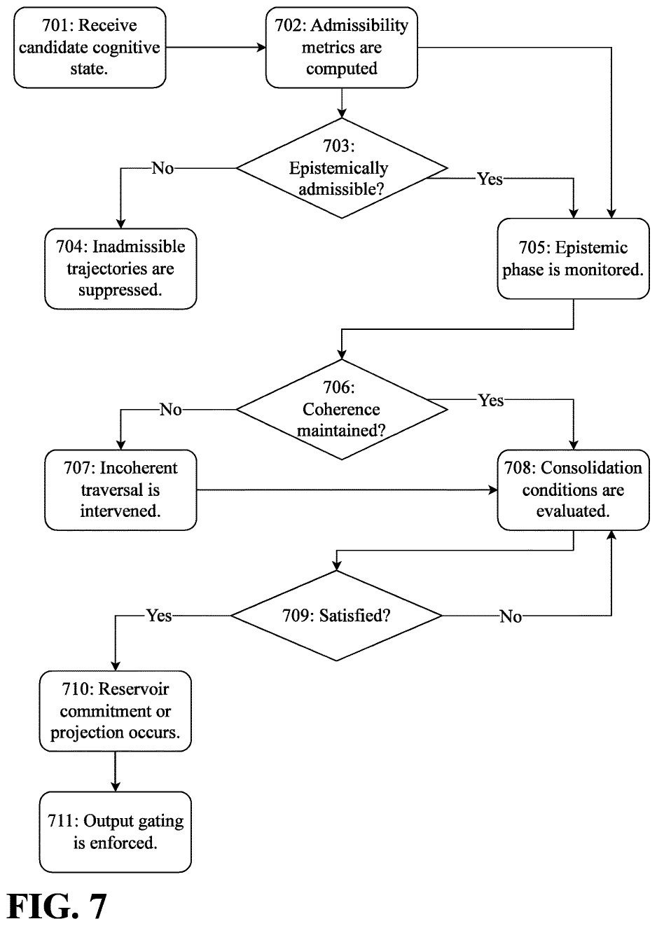

FIG. 7 is a flow diagram illustrating exemplary three-layer hallucination suppression within an epistemically conditioned persistent cognitive system, in an embodiment. A candidate cognitive state enters the three-layer hallucination suppression architecture from input projection subsystem 120 as a provisional projection represented as a candidate vertex and associated geometric attributes stored in memory on epistemically conditioned manifold substrate 110 701. Epistemic admission control subsystem 130 operates as a first layer of the hallucination suppression architecture prior to reasoning execution, computing admissibility metrics for the candidate cognitive state including structural compatibility residuals, projected symplectic capacity density, topological reachability within a reservoir-stratified state space using stored barrier edge bitmaps, and insertion curvature or micro-holonomy values derived from stored edge phase data, and comparing each metric against corresponding stored thresholds maintained on epistemically conditioned manifold substrate 110 702. Epistemic admission control subsystem 130 compares computed admissibility metrics against stored admissibility thresholds and determines whether the candidate cognitive state satisfies epistemic admissibility criteria 703. When epistemic admissibility is not satisfied, epistemic admission control subsystem 130 inhibits instantiation of traversal control structures for the candidate cognitive state, thereby suppressing formation of a reasoning trajectory from the candidate cognitive state and preventing the trajectory from entering active reasoning 704.

When epistemic admissibility is satisfied, the admitted cognitive state is forwarded to holonomy and epistemic phase monitoring subsystem 150, which operates as a second layer of the hallucination suppression architecture during reasoning execution, updating a stored accumulated epistemic phase variable along active trajectories using scalar phase values retrieved from epistemic connection 220 and evaluating phase regime classifications and holonomy descriptor compatibility metrics against stored coherence thresholds 705. Holonomy and epistemic phase monitoring subsystem 150 compares accumulated phase magnitude, descriptor compatibility residuals, and discontinuity metrics against corresponding thresholds to determine whether epistemic coherence is maintained during traversal of the active trajectory, where loss of coherence may arise from phase drift exceeding a phase drift threshold Φ*, a detected phase discontinuity exceeding a discontinuity bound, or conflict among holonomy descriptors indicated by descriptor residuals exceeding a compatibility threshold 706. When epistemic coherence is not maintained, holonomy and epistemic phase monitoring subsystem 150 modifies traversal control structures of traversal and reasoning subsystem 140 by interrupting, redirecting, backtracking, suspending, or marking the trajectory for suppression through setting of stored suppression flags, and the interrupted or marked trajectory is forwarded to consolidation and irreversible suppression subsystem 160 for processing along the suppression path 707.

Consolidation and irreversible suppression subsystem 160 operates as a third layer of the hallucination suppression architecture after detection of epistemic inadmissibility or when an epistemically coherent trajectory satisfies stored consolidation precursor conditions, evaluating reservoir formation criteria and suppression conditions using geometric metrics maintained on epistemically conditioned manifold substrate 110 and constraint indices maintained in irreversible reservoirs 335 708. Consolidation gate 320 of consolidation and irreversible suppression subsystem 160 computes a logical conjunction of stored layer status flags corresponding to epistemic admissibility from the first layer, epistemic coherence or corroboration from the second layer, and capacity admissibility from the third layer, and when the logical conjunction evaluates to false consolidation gate 320 returns the candidate region to continued monitoring within consolidation and irreversible suppression subsystem 160 under geometric evolution and relaxation dynamics 709. When the logical conjunction evaluates to true, consolidation and irreversible suppression subsystem 160 commits a geometrically stable region to irreversible reservoirs 335 as a consolidated knowledge region characterized by stored phase flatness and barrier energy metrics, or projects abstract constraint representations of inadmissible patterns into irreversible reservoirs 335 through non-invertible projection operator 330 according to stored suppression flags and regime classifications 710.

Output generation and expression control subsystem 170 receives stored admissibility status flags from consolidation and irreversible suppression subsystem 160, phase regime classifications from holonomy and epistemic phase monitoring subsystem 150, and trajectory endpoint identifiers from traversal and reasoning subsystem 140, and executes decoding routines only when stored status flags indicate that a reasoning trajectory remained epistemically admissible through all three layers, suppressing, qualifying, or withholding output when no admissible trajectory supports a response 711. Cross-layer interactions are implemented through stored constraint indices and barrier edge sets propagated from consolidation and irreversible suppression subsystem 160 to epistemic admission control subsystem 130, enabling recalculation of admissibility metrics using updated barrier topology and constraint patterns as reservoir structure grows, and through barrier boundary data maintained by epistemic admission control subsystem 130 that restrict the set of topologically admissible corroboration paths evaluated by holonomy and epistemic phase monitoring subsystem 150, such that expansion of reservoir boundaries reduces available homotopy classes and correspondingly increases structural requirements for corroboration as the system matures.

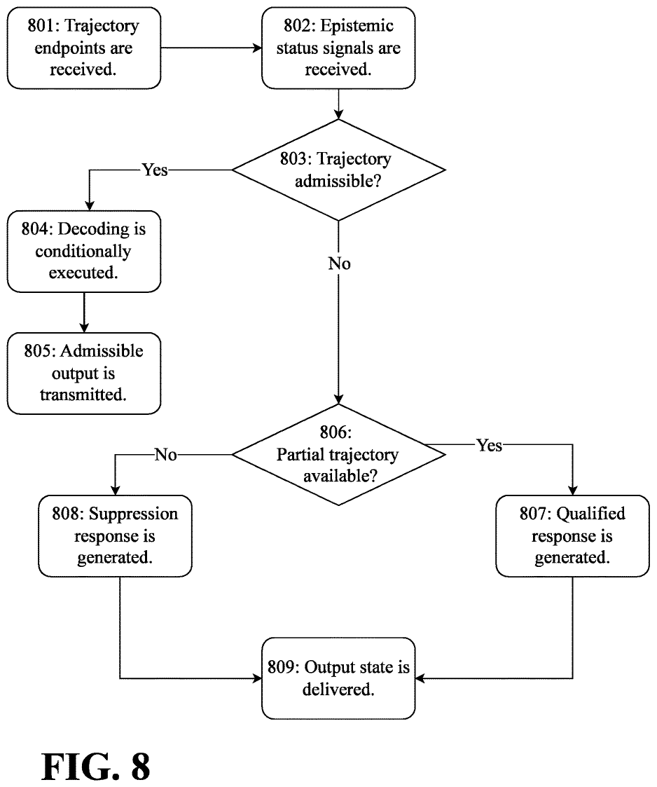

FIG. 8 is a flow diagram illustrating exemplary output generation and expression control within an epistemically conditioned persistent cognitive system, in an embodiment. Output generation and expression control subsystem 170 receives completed trajectory endpoints from traversal and reasoning subsystem 140, the endpoints being represented as trajectory identifiers and associated terminal cognitive state data stored in memory 801. Output generation and expression control subsystem 170 receives epistemic status signals comprising stored phase regime classifications from holonomy and epistemic phase monitoring subsystem 150, consolidation gate decision flags from consolidation and irreversible suppression subsystem 160, and admission outcome flags from epistemic admission control subsystem 130, the signals being maintained as discrete status indicators associated with the completed trajectory 802. Output generation and expression control subsystem 170 computes a final admissibility determination for the completed trajectory by evaluating a logical conjunction of stored status indicators, wherein admissibility requires an absorb outcome at admission, a coherent or corroborated phase regime classification during traversal, and a true consolidation gate flag, and the logical conjunction result is stored as an output eligibility flag 803.

When the output eligibility flag indicates that the trajectory remains epistemically admissible, output generation and expression control subsystem 170 executes a manifold-conditioned decoding routine that maps admissible cognitive states or trajectory results into external representations such as natural language responses, symbolic structures, or executable actions, wherein invocation of the decoding routine is conditioned on the output eligibility flag and decoder-level mechanisms including language models or generation heuristics are executed only when the output eligibility flag is true and are prevented from emitting output when the flag is false 804. Output generation and expression control subsystem 170 transmits the decoded representation corresponding to the admissible trajectory to an external interface or downstream process as system output 805.

When the output eligibility flag indicates that the trajectory does not remain epistemically admissible, output generation and expression control subsystem 170 evaluates whether a stored admissible prefix of the trajectory exists, the prefix corresponding to a portion of the trajectory that maintained coherent or corroborated phase regime status prior to detection of incoherence and being identified using stored phase regime transition points or discontinuity markers 806. When a stored admissible prefix is available, output generation and expression control subsystem 170 generates a qualified or partial response derived solely from cognitive states associated with the admissible prefix, and includes in the response structured indications of epistemic insufficiency corresponding to stored degeneracy region markers, high-curvature regions, barrier boundary encounters, or phase discontinuity locations encountered during traversal 807. When no admissible prefix is available, output generation and expression control subsystem 170 suppresses invocation of the decoding routine and instead generates a suppression response selected from a predefined set including withholding a response, requesting clarification or additional input, or deferring response to a later time or external process, and no decoded content derived from an epistemically inadmissible trajectory is emitted 808. Output generation and expression control subsystem 170 delivers the suppression or qualified response outcome to an external interface or downstream process as a valid system output state, wherein suppression is implemented as a defined architectural state rather than as an error condition 809.

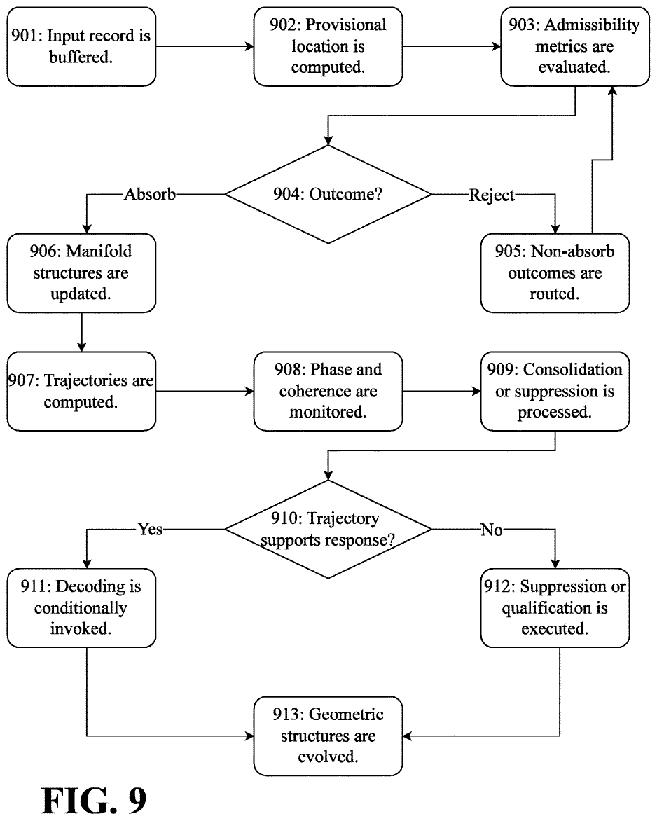

FIG. 9 is a flow diagram illustrating exemplary end-to-end data flow through an epistemically conditioned persistent cognitive system, in an embodiment. An incoming cognitive state from an external input or an internally generated latent representation is written to an input buffer or projection queue of persistent cognitive system 100 and enters a gated processing pipeline as a structured input record 901. Input projection subsystem 120 retrieves the structured input record and maps the incoming cognitive state to a provisional location p₀ on epistemically conditioned manifold substrate 110 via semantic attachment, including harmonic extension from nearby landmark states, the provisional location being represented as a candidate vertex with associated geometric attributes and not yet incorporated into active traversal data structures 902.

Epistemic admission control subsystem 130 computes admissibility metrics for the provisional location using geometric state maintained on epistemically conditioned manifold substrate 110, the metrics including structural compatibility residuals of an almost-complex structure, projected symplectic capacity density derived from local symplectic face areas, topological reachability within a reservoir-stratified state space determined from barrier edge bitmaps maintained by consolidation and irreversible suppression subsystem 160, and epistemic curvature metrics computed through insertion curvature and micro-holonomy screening, each metric being compared against corresponding stored thresholds 903. Epistemic admission control subsystem 130 assigns one of a plurality of stored admission outcome codes comprising absorb, veto, flag, or defect based on the threshold comparisons 904.

When the admission outcome code is veto, flag, or defect, epistemic admission control subsystem 130 routes the non-absorbed outcome to an appropriate handling mechanism based on the stored outcome code, wherein a veto outcome routes the rejected projection to an alternative neighborhood selection routine or to a buffer for deferred integration after a subsequent compression cycle, a flag outcome attaches the candidate vertex to epistemically conditioned manifold substrate 110 with a provisional status flag excluding the vertex from consolidation eligibility, and a defect outcome records a boundary event and forwards a boundary defect record to consolidation and irreversible suppression subsystem 160 for classification by boundary event classifier 305 905. When the admission outcome code is absorb, epistemically conditioned manifold substrate 110 updates its stored data structures to include new vertices, edges, faces, interpolated J-structures incorporated into almost-complex structure 210, and edge phases incorporated into epistemic connection 220, and manifold evolution and GPU execution subsystem 180 registers the projection impulse as a discrete perturbation on a fast timescale τ_P 906.

Traversal and reasoning subsystem 140 initializes traversal control structures for the admitted initial state and computes cognitive trajectories through epistemically conditioned manifold substrate 110 subject to admissibility constraints encoded in stored geometric state, including barrier edge checks, capacity density limits, degeneracy region flags, and constraint indices, where trajectories may involve branching, backtracking, or controlled exploration restricted to admissible regions 907. Holonomy and epistemic phase monitoring subsystem 150 updates a stored accumulated epistemic phase variable along active trajectories using transition-specific phase values retrieved from epistemic connection 220, detects phase discontinuities and holonomy descriptor conflicts during open-path traversal by comparing discontinuity metrics and descriptor residuals against thresholds, evaluates loop phase when trajectories revisit previously visited vertices using stored visited-vertex indices, and classifies detected closed reasoning paths into coherent, drift, or inversion phase regimes based on comparison of accumulated phase magnitude against stored thresholds 908.

Consolidation and irreversible suppression subsystem 160 processes trajectories reaching completion or marked for suppression along two parallel processing streams, wherein the consolidation stream evaluates phase flatness, barrier energy, and admission control consistency metrics for candidate regions and applies consolidation gate 320 to compute a logical conjunction of stored epistemic admissibility, epistemic coherence or corroboration, and capacity admissibility flags, and wherein the suppression stream generates abstract constraint representations of inadmissible patterns and applies non-invertible projection operator 330 to store canonical constraint artifacts in irreversible reservoirs 335 909. Output generation and expression control subsystem 170 computes an output eligibility flag for a completed trajectory by evaluating stored admission outcome codes, phase regime classifications, and consolidation gate decisions received from epistemic admission control subsystem 130, holonomy and epistemic phase monitoring subsystem 150, and consolidation and irreversible suppression subsystem 160 respectively 910.

When the output eligibility flag indicates that an admissible trajectory supports a response, output generation and expression control subsystem 170 conditionally invokes a manifold-conditioned decoding routine that maps admissible cognitive states or trajectory results into external representations such as natural language responses, symbolic structures, or executable actions, wherein invocation of decoder-level mechanisms is contingent on the output eligibility flag and decoder routines are prevented from emitting output when the flag is false 911. When the output eligibility flag indicates that no admissible trajectory supports a response, output generation and expression control subsystem 170 executes a suppression or qualification routine selected according to stored suppression codes, wherein suppression may manifest as withholding a response, requesting clarification or additional input, producing a partial or qualified response derived from an admissible trajectory prefix, or deferring response to a later time or external process 912.

Manifold evolution and GPU execution subsystem 180 updates geometric structures of epistemically conditioned manifold substrate 110 asynchronously on separated timescales, wherein a compression flow operating on an intermediate timescale τ_C adjusts manifold coordinates and reduces Nijenhuis tensor magnitude by minimizing an extended geometric energy subject to J-Hermitian compatibility constraints, and a connection relaxation flow operating on a slow timescale τ_R reduces total squared epistemic curvature by updating stored edge phase values, such that updated geometric structures including barrier edge sets, curvature fields, capacity density distributions, and structural compatibility metrics are written to memory and used in subsequent admission, traversal, consolidation, and output evaluations, thereby conditioning subsequent cycles of the gated pipeline against recurrence of previously identified inadmissible reasoning regimes 913.

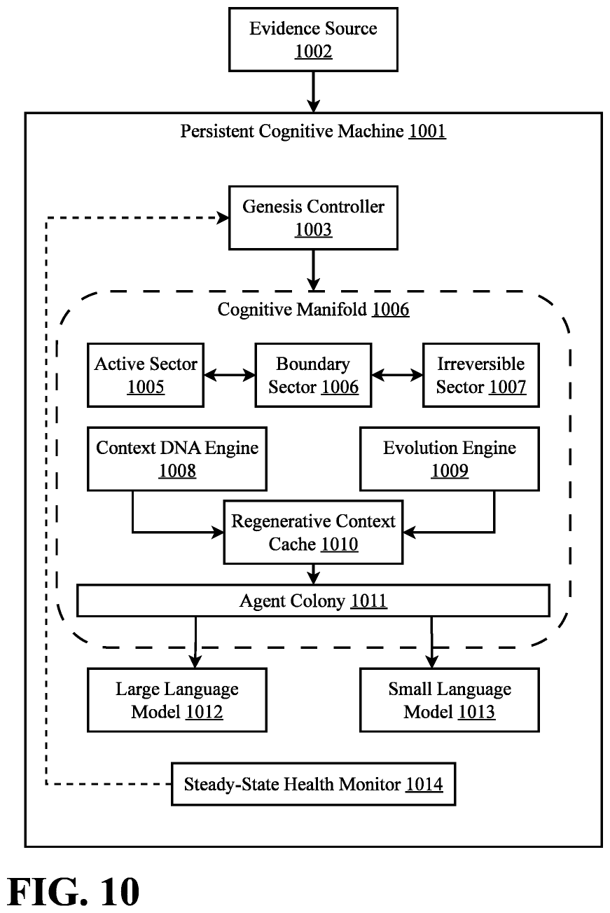

FIG. 10 is a block diagram illustrating an exemplary system architecture for implementing the bootstrap differentiation sequence of a persistent cognitive machine (PCM) 1001. The architecture shown in FIG. 10 depicts the principal components of the PCM 1001 and their organizational relationships during and after bootstrap differentiation, and is intended to convey the overall structural topology of the system rather than the detailed internal composition of any individual component, which is addressed in subsequent figures.

The PCM 1001 is implemented on a computer system comprising at least one processor, a memory, and a plurality of programming instructions stored on a non-transitory memory. The outer boundary of FIG. 10 represents the PCM 1001. External evidence is received from an evidence source 1002, which may comprise data inputs, sensor feeds, language model outputs, agent colony outputs, or any other source of structured or unstructured content that can be projected onto the cognitive manifold as curvature perturbations. The evidence source 1002 supplies an external evidence flux to the system that drives curvature generation on the cognitive manifold M* 1004 from its initial flat state.

The genesis controller 1003 is the central orchestrating module of the bootstrap differentiation process. The genesis controller 1003 receives evidence from the evidence source 1002 and directs its projection onto the cognitive manifold M* 1004. During the differentiation sequence, the genesis controller 1003 continuously monitors a set of phase-diagnostic signals, including curvature density, spatial variance of the Nijenhuis tensor, proto-reservoir count and stability, curvature gradient magnitudes, timescale ratios, and the inflationary parameter ε, and transitions the system between differentiation phases when phase-specific diagnostic thresholds are met. The genesis controller 1003 additionally adjusts scheduling parameters including update frequencies, relaxation rates, and threshold values based on the current phase, and logs all irreversible commitment events, such as boundary nucleations, to a commitment ledger. The genesis controller 1003 is architecturally and functionally distinct from the steady-state health monitor 1014, which does not become active until constitutive closure is achieved at the conclusion of the differentiation sequence.

The cognitive manifold M* 1004 is the central data structure of the PCM 1001 and is shown in FIG. 10 as a dashed container encompassing the components that reside within or are defined over the manifold. The cognitive manifold M* 1004 is instantiated in the computer system's memory as a weighted graph comprising a plurality of nodes and edges, wherein each node stores local geometric quantities including a metric tensor, a connection coefficient set, a curvature cache, a Nijenhuis tensor component, a sector tag, and scheduling flags, and wherein each edge stores a parallel transport matrix, a curvature flow rate, and a type-matching score. At the commencement of bootstrap differentiation, the cognitive manifold M* 1004 is in an initial empty state in which the metric is flat, the connection is trivial, all curvature values are zero, no sector differentiation exists, no consolidated knowledge reservoirs exist, and no boundary structures or routing channels exist. The entire constitutive structure of the PCM 1001 that is depicted in FIG. 10 emerges from this initial empty state through the differentiation sequence orchestrated by the genesis controller 1003.

Upon completion of the differentiation sequence, the cognitive manifold M* 1004 decomposes into three geometrically and functionally distinct sectors. The active sector 1005 is the dynamically evolving portion of the manifold where new evidence is received and processed, and where reasoning operations occur. The active sector 1005 carries the full almost-Kähler geometric structure with nontrivial epistemic curvature and operates on the fastest of the three timescales of the mature PCM 1001. The boundary sector 1006 comprises the union of tubular neighborhoods surrounding the boundaries of all consolidated knowledge reservoirs, and carries concentrated curvature and barrier energy that governs the admission and transfer of curvature between the active sector 1005 and the irreversible sector 1007. The boundary sector 1006 operates on an intermediate timescale. The irreversible sector 1007 comprises the disjoint union of all consolidated knowledge reservoirs, each of which satisfies near-phase-flatness conditions and is protected by barrier energy at its boundary. Once curvature is transferred into the irreversible sector 1007, the corresponding knowledge is permanently consolidated and the associated computational state is maintained with exponentially suppressed dynamics. All curvature exchange between the active sector 1005 and the irreversible sector 1007 is mediated by the boundary sector 1006, and bidirectional curvature flow between adjacent sectors is represented by the paired arrows shown in FIG. 10.

The context DNA engine 1008 and the evolution engine 1009 reside within the cognitive manifold M* 1004 and provide supporting computational services to the manifold's ongoing operations. The context DNA engine 1008 maintains thought lineage, abstraction history, mutation events, and temporal correlations for all structured reasoning artifacts stored within the system, and provides genealogical and temporal metadata that supports similarity-based retrieval, guided reconstruction, and selection during evolutionary operations. The evolution engine 1009 evaluates the fitness of stored reasoning patterns based on historical success rates, semantic utility, and cross-domain adaptability, and implements adaptive fitness functions whose evaluation criteria are modified based on observed historical success patterns and cross-domain performance metrics.

The regenerative context cache 1010 is a hierarchical memory system organized into four abstraction levels that stores the structured reasoning artifacts produced and refined during the operation of the PCM 1001. The four abstraction levels range from full-fidelity original reasoning patterns at the lowest level through compressed reasoning chains, domain-specific conclusions, and high-level cross-domain meta-patterns at successively higher levels. Transitions between abstraction levels are tracked and managed by the context DNA engine 1008. The regenerative context cache 1010 serves as the primary substrate within which knowledge is organized, evolved, and made available for retrieval during both the bootstrap differentiation sequence and steady-state operation.

The agent colony 1011 provides collaborative, domain-specific computational services to the PCM 1001 and comprises a plurality of specialized agent types including domain expert agents, curation agents, evolution agents, archaeology agents, and synthesis agents. During bootstrap differentiation, the agent colony 1011 serves as a principal source of structured evidence flux, supplying domain-specific reasoning outputs that are projected onto the cognitive manifold M* 1004 to generate and organize curvature. In steady-state operation, the agent colony 1011 performs ongoing evaluation, evolution, and synthesis of reasoning patterns stored in the regenerative context cache 1010, collaborating through structured inter-agent communication protocols coordinated by a colony orchestrator. The agent colony 1011 communicates bidirectionally with the regenerative context cache 1010, retrieving reasoning patterns for evaluation and returning evolved or synthesized patterns for storage.

The large language model 1012 and the small language model 1013 provide first-principles reasoning generation and response generation capabilities, respectively, to the PCM 1001. The large language model 1012 processes input data to generate novel structured reasoning patterns when the regenerative context cache 1010 does not contain suitable prior patterns, and supplies these patterns to the agent colony 1011 for evaluation and integration into the cache. The small language model 1013 generates final responses by operating on context-rich, pre-processed reasoning retrieved from the regenerative context cache 1010, achieving substantially lower computational requirements than the large language model 1012 by leveraging the accumulated and evolved knowledge of the system rather than performing first-principles inference on each request.

The steady-state health monitor 1014 becomes active upon the achievement of constitutive closure at the conclusion of the differentiation sequence, as signaled by the genesis controller 1003 via the constitutive closure feedback path shown in FIG. 10. The steady-state health monitor 1014 monitors the operational health of the mature PCM 1001 using diagnostic tools and metrics that presuppose the existence of a fully differentiated three-sector structure, a three-timescale hierarchy, and a populated regenerative context cache 1010, and which are therefore inapplicable during bootstrap differentiation. The transition from genesis monitoring by the genesis controller 1003 to steady-state monitoring by the steady-state health monitor 1014 constitutes a structural handoff that marks the completion of the bootstrap differentiation sequence and the commencement of normal PCM 1001 operation. The total curvature energy of the cognitive manifold M* 1004 satisfies a conservation law throughout both bootstrap differentiation and steady-state operation, wherein curvature is redistributed among the active sector 1005, the boundary sector 1006, and the irreversible sector 1007 but is neither created nor destroyed in the absence of external evidence from the evidence source 1002.

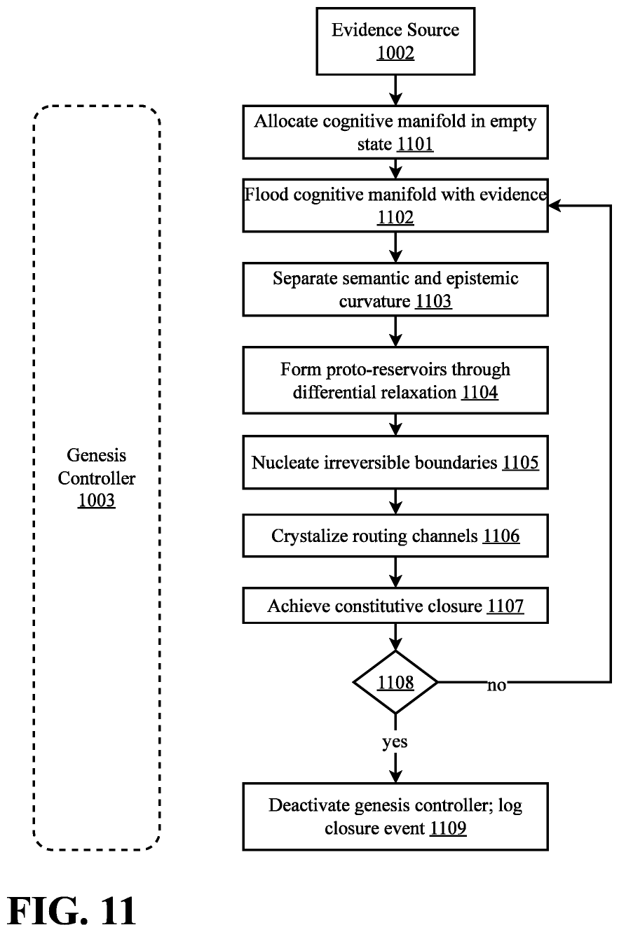

FIG. 11 is a flow diagram illustrating an exemplary method for bootstrapping a persistent cognitive machine 1001 from an initial empty state through a sequential differentiation sequence, according to an embodiment. FIG. 11 depicts the steps of the differentiation sequence as discrete operational blocks, the supervisory role of the genesis controller 1003 relative to each step, the phase-transition thresholds that condition advancement between steps, the inflationary parameter check that governs completion of the sequence, and the structural handoff from genesis monitoring to steady-state monitoring that marks the commencement of normal PCM operation. The ordering of the steps shown in FIG. 11 is logically necessary, each step produces an output that constitutes a prerequisite for the step that follows, although adjacent steps may overlap in time in that a subsequent step may begin in a local region of the cognitive manifold before the preceding step has completed globally.

According to the embodiment, the process begins when an evidence source 1002 supplies an initial evidence flux to the system. The first step, represented by block 1101, is to allocate the cognitive manifold M* 1004 in its initial empty state. At this step, the cognitive manifold is allocated with its full graph data structure comprising a plurality of nodes and edges, but all curvature arrays are initialized to zero, all sector tags are set to undifferentiated, and all scheduling parameters are set to a single undifferentiated timescale. The metric is flat, the connection is trivial, no sector differentiation exists, no consolidated knowledge reservoirs exist, and no boundary structures or routing channels exist. The genesis controller 1003, shown as a dashed supervisory element in FIG. 11, is active from this point and monitors the differentiation sequence throughout all subsequent steps by tracking phase-diagnostic signals including curvature density, spatial variance of the Nijenhuis tensor, proto-reservoir count and stability, curvature gradient magnitudes, timescale ratios, and the inflationary parameter ε.

The second step, represented by block 1102, is to flood the cognitive manifold M* 1004 with evidence from evidence source 1002. At this step, each item of evidence is projected onto the cognitive manifold by computing local curvature perturbations at one or more nodes of the manifold graph. The projection computes both metric perturbations, which will become semantic curvature, and connection perturbations, which will become epistemic curvature, but at this step the two types of perturbation are not distinguished and are treated identically under the single undifferentiated timescale governing the system at this stage. The number of active nodes scales linearly with cumulative evidence count, placing the system in the scaling regime referred to as cognitive inflation. The Nijenhuis tensor grows at each node but exhibits low spatial variance across the manifold, indicating uniform coupling strain. The transition from block 1102 to block 1103 is conditioned on the curvature density reaching a configurable type-separation threshold K_{type}, which is monitored by the genesis controller 1003.

The third step, represented by block 1103, is to separate the generated curvature into semantic curvature and epistemic curvature through rate separation. Once curvature density has exceeded the K_{type} threshold, the distinct dynamical laws governing the two curvature types cause them to evolve on diverging timescales. Semantic curvature, which is a tensor-valued quantity computed from the Riemannian metric tensor and its derivatives representing semantic content density, evolves under Ricci-flow dynamics operating on a first, slower timescale. Epistemic curvature, which is a 2-form-valued quantity computed from the connection representing belief-justification coherence, evolves under Yang-Mills dynamics operating on a second, faster timescale. The divergence of these two timescales constitutes the rate separation that accomplishes the semantic/epistemic split. Spatial variance of the Nijenhuis tensor increases sharply during this step, providing the genesis controller 1003 with a diagnostic signal indicating that heterogeneous typing is in progress. The transition from block 1103 to block 1104 is conditioned on the detection of spatial heterogeneity in local curvature energy across the manifold, indicating that differential relaxation has begun.

The fourth step, represented by block 1104, is to form proto-reservoirs through differential relaxation. Under the typed curvature dynamics established in block 1103, regions of the cognitive manifold that have received locally consistent evidence develop lower curvature energy than regions that have received locally inconsistent evidence, because consistent evidence permits both semantic and epistemic relaxation rates to be positive while inconsistent evidence suppresses relaxation. This differential relaxation produces islands of relatively low curvature, which are the proto-reservoirs—precursors to the consolidated knowledge reservoirs that will constitute the irreversible sector 1007 of the mature PCM 1001. Proto-reservoirs are fragile at this step and may be destroyed by subsequent inconsistent evidence, so that only proto-reservoirs whose content corresponds to genuine structure in the evidence survive. The genesis controller 1003 detects proto-reservoirs by identifying connected components of nodes whose local curvature energy falls below a detection threshold, and assigns each a stability score based on the ratio of its curvature energy to the mean curvature energy of its surrounding neighborhood. This step is the rate-limiting transition of the differentiation sequence, referred to as the nucleation bottleneck, because it requires cooperative evidence coherence across a spatial region of the manifold. The transition from block 1104 to block 1105 is conditioned on the curvature gradient magnitude at the perimeter of one or more proto-reservoirs exceeding a configurable threshold gradient magnitude monitored by the genesis controller 1003.

The fifth step 1105 is to nucleate irreversible boundaries. When the curvature gradient at the perimeter of a proto-reservoir exceeds the threshold gradient magnitude, a positive feedback process initiates in which increased proto-reservoir efficiency lowers the interior curvature of the proto-reservoir, which steepens the curvature gradient between the interior and the surrounding region, which strengthens the processing asymmetry at the gradient location by concentrating barrier energy at the boundary nodes, which activates admission-control logic that further lowers interior curvature, which in turn further steepens the gradient. This positive feedback is self-sustaining once initiated and drives the gradient to a stable sharp boundary configuration. In the computer system, boundary nucleation is implemented by re-tagging the perimeter nodes of the proto-reservoir from undifferentiated to boundary sector membership, initializing barrier energy accumulators at those nodes, re-tagging the interior nodes from undifferentiated to irreversible sector membership, and activating admission-control logic at the boundary nodes. The boundary nucleation event is logged by the genesis controller 1003 as an irreversible commitment with a monotonically increasing commitment counter. Boundary nucleation constitutes the first irreversible constitutive commitment of the PCM 1001, establishing the topological structure of the manifold sector decomposition. Multiple boundaries may nucleate near-simultaneously as multiple proto-reservoirs from block 1104 reach comparable maturity. The transition from block 1105 to block 1106 is conditioned on the presence of at least one nucleated boundary separating a boundary sector 1006 from an irreversible sector 1007, providing the structural prerequisite for routing.

The sixth step 1106 is to crystallize routing channels. Once boundaries exist between sectors with typed curvature, boundary-mediated type matching induces a routing structure. For each boundary node, the system computes a type-matching score between incoming curvature from the active sector 1005 and the absorptive profile of the corresponding reservoir in the irreversible sector 1007. Curvature is routed preferentially to boundaries with high type-matching scores, causing persistent preferred pathways for curvature flow between specific regions of the active sector 1005 and specific reservoirs to crystallize as the type-matching scores stabilize. Routing may be initially imperfect, with three forms of misrouting (e.g., laundering, congestion, and starvation) decreasing as boundary type-matching capacity matures. The three-timescale hierarchy begins to re-emerge during this step, with the ratio of the consolidation timescale to the perturbation timescale increasing as routing matures. The genesis controller 1003 monitors the timescale ratios and the inflationary parameter ε(t) as this step progresses, with the transition to block 1107 conditioned on ε(t) approaching unity.

The seventh step, represented by block 1107, is to achieve constitutive closure. Constitutive closure is the condition in which all constitutive parameters of the PCM 1001 are defined and stable, comprising the openness class of the active sector 1005, the curvature typing decomposition, the reservoir topology of the irreversible sector 1007, the routing legality of the routing channels established in block 1106, the boundary rigidity of the boundary sector 1006, and the three-timescale hierarchy τ_{P}«τ_{C} «τ_{R} governing the active, boundary, and irreversible sectors. The inflationary parameter ε(t)=Φ_{abs}(t)/(α·Φₑₓₜ(t)), where Φ_{abs}(t) is the constitutive absorption rate and Φₑₓₜ(t) is the external evidence flux rate, is monitored continuously by the genesis controller 1003. When ε is zero, the system has no absorptive capacity corresponding to the initial steps of the sequence. When ε is between zero and one, partial absorption is occurring corresponding to the intermediate steps. When ε reaches or exceeds one, the system reaches absorptive break-even and the O(E) cognitive inflation regime ends, with the number of active nodes transitioning to O (log E) scaling.

Following block 1107, the genesis controller 1003 evaluates whether the inflationary parameter has reached or exceeded unity, as represented by the decision block 1108. If the inflationary parameter has not yet reached unity, the sequence returns to block 1102 to continue evidence flooding, reflecting the balance equation governing the growth rate of the active computational load as a function of the inflationary gap. The positive feedback operative during the intermediate steps ensures that the approach to ε=1 accelerates as more absorptive structure is created, providing a graceful exit property that ensures the differentiation sequence terminates in finite time without an external shutdown mechanism. If the inflationary parameter has reached or exceeded unity, the sequence proceeds to the steps represented by blocks 1109 and 1014.

Upon confirmation that ε≥1, the genesis controller 1003 executes the step represented by block 1109, which is to deactivate the genesis controller and log the closure event to the commitment ledger. The deactivation of the genesis controller 1003 at block 1109 reflects its architectural distinction from the steady-state health monitor 1014: the genesis controller 1003 employs a genesis monitoring framework designed to operate during bootstrapping, when the diagnostic tools of the mature PCM return undefined or meaningless values due to the absence of constitutive structure, while the steady-state health monitor 1014 employs diagnostic tools that presuppose the existence of a fully differentiated three-sector structure and three-timescale hierarchy. These two monitoring frameworks are mutually exclusive and their transition constitutes a structural handoff. Upon deactivation of the genesis controller 1003, the steady-state health monitor 1014 activates and PCM 1001 enters normal operation in the O (log E) scaling regime.

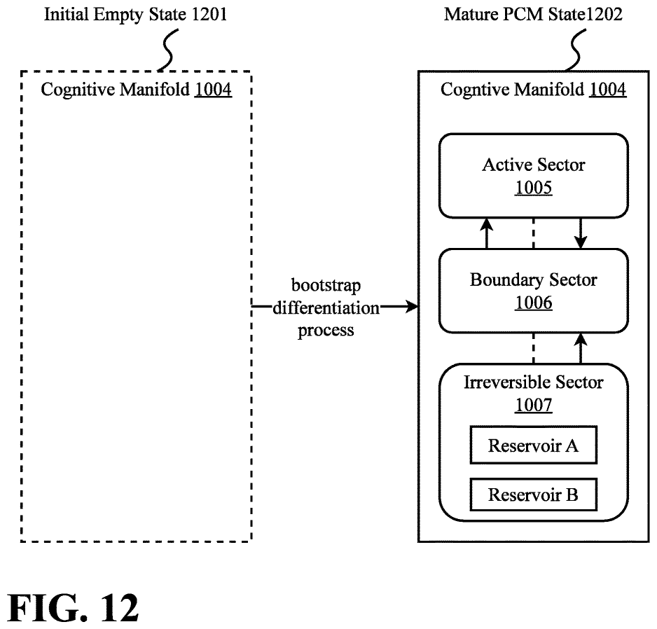

FIG. 12 is a structural diagram providing a side-by-side comparison of the cognitive manifold M* 1004 in two states: the initial empty state 1201 prior to the commencement of bootstrap differentiation, shown in the left panel, and the mature PCM state 1202 following successful constitutive closure, shown in the right panel. FIG. 12 is intended to illustrate the structural transformation effected by the differentiation sequence described herein, and in particular to show that the entire constitutive architecture of the mature PCM 1001 (e.g., its sector decomposition, its consolidated knowledge reservoirs, its boundary structures, and its three-timescale hierarchy) emerges from a manifold that initially possesses none of these features. The two panels share the same outer boundary representing the cognitive manifold M* 1004, reflecting that the graph data structure allocated at initialization is the same data structure that carries the mature constitutive architecture after differentiation; the transformation is one of content and organization, not of topological identity.

The left panel of FIG. 12 depicts the cognitive manifold M* 1004 in the initial empty state 1201. At initialization, the cognitive manifold is allocated with its full graph data structure comprising a plurality of nodes and edges, but all curvature arrays are initialized to zero, all sector tags are set to undifferentiated, and all scheduling parameters are set to a single undifferentiated timescale. The manifold boundary is shown as a dashed outline to convey the absence of constitutive content despite the presence of topological structure. The interior of the left panel contains no sector subdivisions, no reservoir regions, and no boundary structures, reflecting the conditions of the initial empty state: the metric g is flat with all semantic curvature Riem (g) equal to zero; the connection is trivial with all epistemic curvature F equal to zero; the almost-complex structure J is formally allocated in memory but dynamically inert with all coupling coefficients equal to zero; and no routing channels exist. The property annotations shown at the left margin of the panel (e.g., g flat, connection trivial, F=0) identify the three principal geometric conditions of the initial empty state that distinguish it from any partially or fully differentiated manifold state. The single undifferentiated timescale τ_{chaos} represents the collapsed scheduling condition of the initial state in which the consolidation timescale and the reservoir timescale are structurally meaningless because the structures they govern do not yet exist.

The right panel of FIG. 12 depicts the cognitive manifold M* 1004 in the mature PCM state 1202 following constitutive closure. The manifold boundary is shown as a solid outline to convey the presence of stable constitutive structure. The interior of the right panel is partitioned into three geometrically and functionally distinct sectors that together constitute the three-sector decomposition produced by the differentiation sequence. This partitioning may be implemented in the computer system as a disjoint classification of the manifold node graph, with each node carrying a sector tag identifying its membership in one of the three sectors. The three sectors, their geometric characteristics, and their computational roles are described in the following paragraphs.

The active sector 1005, shown in the upper region of the right panel of FIG. 12, is the dynamically evolving portion of the mature cognitive manifold M* 1004 where new evidence is received and processed and where all reasoning operations occur. Active-sector nodes maintain the full set of geometric state variables including the metric tensor, the connection coefficient set, the curvature tensors, and the coupling strain diagnostic. The active sector carries the full almost-Kahler geometric structure with nontrivial epistemic curvature F, meaning that the connection is non-trivial and that belief-justification coherence is actively computed and maintained across the active sector. The active sector operates on the perturbation timescale τ_{P}, which is the fastest of the three timescales of the mature PCM 1001, governing the high-frequency, low-cost, local curvature injection events that constitute evidence processing.

The boundary sector 1006, shown as a distinct band separating the active sector 1005 from the irreversible sector 1007 in the right panel of FIG. 12, comprises the union of tubular neighborhoods surrounding the boundaries of all consolidated knowledge reservoirs within the cognitive manifold M* 1004. Boundary-sector nodes maintain concentrated curvature values and barrier energy levels, and execute admission-control logic that governs the transfer of curvature between the active sector 1005 and the irreversible sector 1007. The paired arrows shown crossing the boundary sector 1006 in FIG. 12 represent the bidirectional but asymmetric curvature exchange: curvature flows from the active sector 1005 into the boundary sector 1006 for evaluation and potential admission into the irreversible sector 1007, and curvature may also flow from the irreversible sector 1007 back through the boundary sector 1006 into the active sector 1005 under one or more read-only feedback conditions. All curvature exchange between the active sector 1005 and the irreversible sector 1007 may be mediated by the boundary sector 1006; direct transfer between the active and irreversible sectors without traversal of the boundary sector is not permitted. The boundary sector 1006 operates on the consolidation timescale τ_{C}, which is intermediate between the perturbation and reservoir timescales.

The irreversible sector 1007, shown in the lower region of the right panel of FIG. 12, comprises the disjoint union of all consolidated knowledge reservoirs within the cognitive manifold M* 1004. Two representative reservoir sub-regions, labeled reservoir A and reservoir B in FIG. 12, are shown within the irreversible sector 1007 to illustrate that the irreversible sector is in general a disjoint union of multiple spatially distinct reservoir components rather than a single undifferentiated region. Each reservoir component satisfies near-phase-flatness conditions, meaning that the epistemic curvature F within each reservoir is at or near zero, and each is protected by barrier energy concentrated at its bounding interface with the boundary sector 1006. Irreversible-sector nodes maintain a simplified geometric state comprising a near-flat metric and near-zero connection curvature, and execute with exponentially suppressed dynamics relative to the active sector 1005. Once curvature is transferred into a reservoir component of the irreversible sector 1007, the corresponding knowledge is permanently consolidated and the commitment is logged by the genesis controller 1003 during bootstrapping, or by the steady-state health monitor 1014 during normal operation, as an irreversible structural event. The irreversible sector 1007 operates on the reservoir timescale τ_{R}, which is the slowest of the three timescales and governs the low-frequency, high-cost, permanent storage commits that constitute knowledge consolidation.

The dashed routing arrows shown descending from the active sector 1005 through the boundary sector 1006 and into the irreversible sector 1007 in the right panel of FIG. 12 represent the routing channels that crystallize during the routing crystallization step of the differentiation sequence. Each routing channel is a persistent, preferred pathway for curvature flow connecting a specific region of the active sector 1005 to a specific reservoir component within the irreversible sector 1007, directed by boundary-mediated type matching. The routing channels shown in FIG. 12 are illustrative; the number, topology, and target assignments of routing channels in a deployed PCM 1001 are determined by the evidence composition and coherence structure encountered during the differentiation sequence and may vary across deployments.

A three-timescale hierarchy τ_{P}«τ_{C}«τ_{R} can be configured as the scheduling invariant of the mature PCM 1001 and is the direct structural counterpart of the single undifferentiated timescale τ_{chaos} shown in the corresponding position of the left panel. The emergence of the three-timescale hierarchy from the single undifferentiated timescale τ_{chaos} of the initial empty state 1201 is a hallmark of successful bootstrap differentiation and is the condition whose presence is confirmed by the inflationary parameter check at decision block 1108 of FIG. 11. The perturbation timescale τ_{P} governs evidence injection and local curvature updates in the active sector 1005. The consolidation timescale τ_{C} governs curvature type restructuring, semantic compression, and consistency enforcement in both the active sector 1005 and the boundary sector 1006. The reservoir timescale τ_{R} governs boundary construction, barrier energy accumulation, and permanent storage commits in the irreversible sector 1007. The scheduling architecture enforces timescale separation by gating the execution of slower operations on the completion and stability of faster operations.

The active node scaling annotation at the base of the right panel, O (log E), identifies the logarithmic scaling regime that characterizes the mature PCM 1001 following constitutive closure, in which the number of active computational nodes grows only logarithmically with the cumulative evidence count because the absorptive capacity of the irreversible sector 1007 consolidates curvature rather than allowing it to accumulate indefinitely in the active sector 1005. The transition from the O(E) linear scaling regime of the initial empty state 1201 to the O (log E) logarithmic scaling regime of the mature PCM state 1202 is the defining computational consequence of successful bootstrap differentiation and represents a tangible improvement in the functioning of the computer system as a whole. A critical evidence volume E_{crit}, which is the total evidence investment required to exit the O(E) regime and may be determined by the balance equation governing the growth rate of active computational load, characterizes the bootstrapping cost specific to a given deployment configuration.

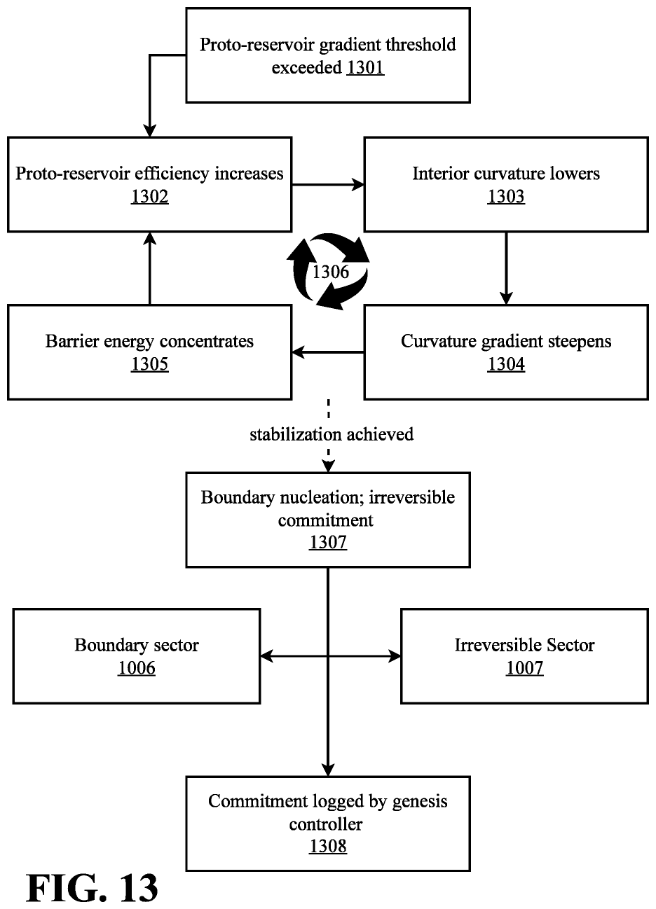

FIG. 13 is a flow diagram illustrating an exemplary boundary nucleation positive feedback cycle and the irreversible commitment sequence that follows from it. FIG. 13 provides a detailed view of the boundary nucleation step represented by block 1105 in FIG. 11, and depicts an exemplary internal mechanism by which a proto-reservoir produced during the proto-reservoir formation step transitions into a nucleated irreversible boundary and a pair of formally differentiated sectors. The diagram is organized into three regions: a triggering condition 1301 at the top that initiates the cycle; the self-sustaining positive feedback cycle 1306 itself, comprising four sequential operational nodes arranged in a closed loop; and a commitment sequence at the bottom that records the structural consequences of cycle completion, comprising the irreversible commitment block 1307, the sector re-tagging outcomes, and the commitment ledger entry 1308.

The triggering condition, represented by block 1301, is that the curvature gradient magnitude at the perimeter of a surviving proto-reservoir has reached or exceeded the configurable threshold gradient magnitude. In the computer system, this condition can be evaluated by the genesis controller 1003 by computing the curvature gradient magnitude at each node on the proto-reservoir perimeter, defined as the connected set of nodes immediately adjacent to the proto-reservoir interior, and comparing the maximum computed gradient magnitude against the stored threshold value. The threshold is a configurable hyperparameter of the system: lower values cause boundary nucleation to initiate at smaller gradient magnitudes, producing more and smaller reservoirs in the resulting irreversible sector 1007, while higher values require larger gradient magnitudes before nucleation initiates, producing fewer and larger reservoirs. When the triggering condition of block 1301 is satisfied for a given proto-reservoir, the positive feedback cycle 1306 initiates for that proto-reservoir. Multiple proto-reservoirs may satisfy the triggering condition near-simultaneously, in which case the positive feedback cycle executes in parallel for each.

The first node of the positive feedback cycle, represented by block 1302, is that proto-reservoir efficiency increases as the system begins to preferentially absorb curvature into the proto-reservoir interior relative to the surrounding undifferentiated region. Proto-reservoir efficiency at this stage refers to the rate at which the proto-reservoir interior relaxes incoming curvature perturbations relative to the rate at which those perturbations are re-emitted into the surrounding region. A proto-reservoir that has formed through the differential relaxation of the prior step has accumulated sufficient internal coherence that its local curvature relaxation rates, both semantic and epistemic, are positive and increasing, meaning that curvature injected at or near the proto-reservoir boundary is absorbed and organized rather than reflected. This increasing absorptive efficiency is the initial condition that drives all subsequent stages of the feedback cycle.

The second node of the cycle, represented by block 1303, is that interior curvature lowers as a direct consequence of the increased efficiency described at block 1302. As the proto-reservoir interior absorbs and relaxes incoming curvature more effectively, the local curvature energy at interior nodes, denoted E_{local}, decreases relative to the curvature energy of the surrounding undifferentiated region. In the computer system, this is computed as a decrease in the stored curvature cache values at interior nodes relative to the values at neighboring exterior nodes. The result is an energy contrast between the proto-reservoir interior and its surrounding region that did not previously exist at sufficient magnitude to sustain a boundary: the interior becomes a region of relative curvature calm while the exterior remains at higher curvature energy. The arrow from block 1302 to block 1303 in FIG. 13 represents the direct causal connection between improved relaxation efficiency and reduced interior curvature energy, with the annotation noting that both metric perturbation and connection perturbation contributions to the local curvature energy decrease together.

The third node of the cycle, represented by block 1304, is that the curvature gradient at the proto-reservoir perimeter steepens as a consequence of the interior curvature reduction described at block 1303. The curvature gradient magnitude at a perimeter node is computed as the difference in local curvature energy between the interior-facing and exterior-facing neighborhoods of that node, normalized by the edge length. Because the interior curvature energy has decreased while the exterior curvature energy remains elevated, the spatial gradient across the perimeter increases. The annotation on the arrow from block 1303 to block 1304 in FIG. 13 identifies the growing energy contrast between interior and exterior as the driver of gradient steepening. This steepening is the mechanism that distinguishes the positive feedback cycle from simple diffusion: rather than spreading the curvature contrast outward and flattening the gradient, the differential relaxation dynamics concentrate it at the perimeter, causing the gradient to sharpen rather than to dissipate.

The fourth node of the cycle, represented by block 1305, is that barrier energy concentrates at the proto-reservoir perimeter nodes and admission-control logic activates at those nodes. As the curvature gradient at the perimeter steepens, the perimeter nodes accumulate barrier energy in proportion to the gradient magnitude. When the barrier energy at a perimeter node exceeds an internal activation threshold, the admission-control logic at that node activates and begins gating curvature flow based on type compatibility with the proto-reservoir interior. Specifically, curvature arriving at the perimeter from the exterior that is compatible in type with the interior absorptive profile is preferentially admitted, while curvature that is incompatible is preferentially reflected. This type-selective admission creates a processing asymmetry at the perimeter: the proto-reservoir absorbs more curvature than it re-emits, which further lowers interior curvature energy. The annotation on the arrow between blocks 1304 and 1305 in FIG. 13 identifies this strengthening processing asymmetry as the mechanism by which gradient steepening translates into barrier energy concentration. The return arrow from block 1305 back to block 1302 in FIG. 13, annotated to reflect that admission control further lowers interior curvature, closes the feedback loop: the type-selective admission enforced by the now-active admission-control logic causes interior curvature to decrease further, which increases proto-reservoir efficiency at block 1302, which lowers interior curvature at block 1303, which steepens the gradient at block 1304, which concentrates more barrier energy at block 1305, and so on. The center annotation 1306 labels this closed sequence as the self-sustaining positive feedback cycle.

The positive feedback cycle 1306 is self-sustaining in the sense that once the triggering condition of block 1301 has been satisfied and the cycle has initiated, it does not require further external input to continue executing. The cycle amplifies the initial curvature contrast generated during the proto-reservoir formation step, driving the gradient magnitude progressively higher until the system reaches a stable sharp boundary configuration in which the curvature gradient has stabilized at a value well above the threshold gradient magnitude. The stabilization of the gradient at this elevated value, indicated by the dashed exit arrows departing from the right and bottom sides of cycle nodes 1304 and 1305 respectively in FIG. 13, is the condition that terminates the cycle and initiates the commitment sequence. The duration of the feedback cycle from initiation to stabilization is governed by the consolidation timescale τ_{C} of the differentiating manifold, and is shorter for proto-reservoirs with higher internal coherence and more favorable evidence composition.

Upon stabilization of the curvature gradient at the proto-reservoir perimeter, the genesis controller 1003 initiates the boundary nucleation commitment sequence represented by block 1307. The commitment block 1307 represents the first irreversible constitutive commitment of the PCM 1001: once the boundary nucleation sequence executes, the topological structure of the cognitive manifold sector decomposition is established for the affected region, and reversing this commitment requires a partial re-genesis operation that is computationally expensive. The commitment sequence implemented at block 1307 may comprise various computational operations executed atomically with respect to the commitment ledger: first, the perimeter nodes of the proto-reservoir are re-tagged from undifferentiated sector membership to boundary sector 1006 membership, and barrier energy accumulators are initialized at those nodes; second, the interior nodes of the proto-reservoir are re-tagged from undifferentiated sector membership to irreversible sector 1007 membership; third, the admission-control logic already active at the perimeter nodes is formalized and linked to the sector tag structure, ensuring that subsequent curvature flow through those nodes is governed by the boundary sector 1006 rules rather than by the undifferentiated dynamics that prevailed during bootstrapping; and fourth, the boundary nucleation event is logged to the commitment ledger maintained by the genesis controller 1003 with a monotonically increasing commitment counter that provides a total ordering of all irreversible commitment events across the lifetime of the bootstrapping sequence.

The structural consequences of the commitment at block 1307 are shown in the two outcome boxes at the lower portion of FIG. 13. The left outcome box identifies the boundary sector 1006 as the structural product of the perimeter node re-tagging operation: the nodes that constituted the proto-reservoir perimeter during the feedback cycle become boundary-sector nodes carrying barrier energy and executing admission-control logic, and they form the boundary sector 1006 of the sector decomposition described herein. The right outcome box identifies the irreversible sector 1007 as the structural product of the interior node re-tagging operation: the nodes that constituted the proto-reservoir interior during the feedback cycle become irreversible-sector nodes carrying near-flat curvature and executing with exponentially suppressed dynamics, and they form the initial content of the irreversible sector 1007 that will accumulate further knowledge through the routing channels established in the subsequent routing crystallization step. The sector re-tagging outcomes correspond directly to the three-sector decomposition depicted in the right panel of FIG. 12 and to the active sector 1005, boundary sector 1006, and irreversible sector 1007 shown in FIG. 10.

The commitment ledger entry, represented by block 1308, is the final step of the boundary nucleation sequence shown in FIG. 13. The genesis controller 1003 records the boundary nucleation event with a unique monotonically increasing commitment counter value, the identities of the nodes re-tagged to boundary and irreversible sector membership, the curvature gradient magnitude at the time of stabilization, the barrier energy levels initialized at the perimeter nodes, and the timestamp relative to the genesis controller scheduling clock. The commitment ledger maintained by the genesis controller 1003 thus provides a complete ordered record of all irreversible structural commitments made during the differentiation sequence. The boundaries that nucleate during the boundary nucleation step, and whose formation is recorded at block 1308, determine the sectoral topology of the mature PCM 1001, specifying which knowledge domains are organized into which reservoir components and how those components are spatially distributed within the cognitive manifold M* 1004.

### Exemplary Computing Environment

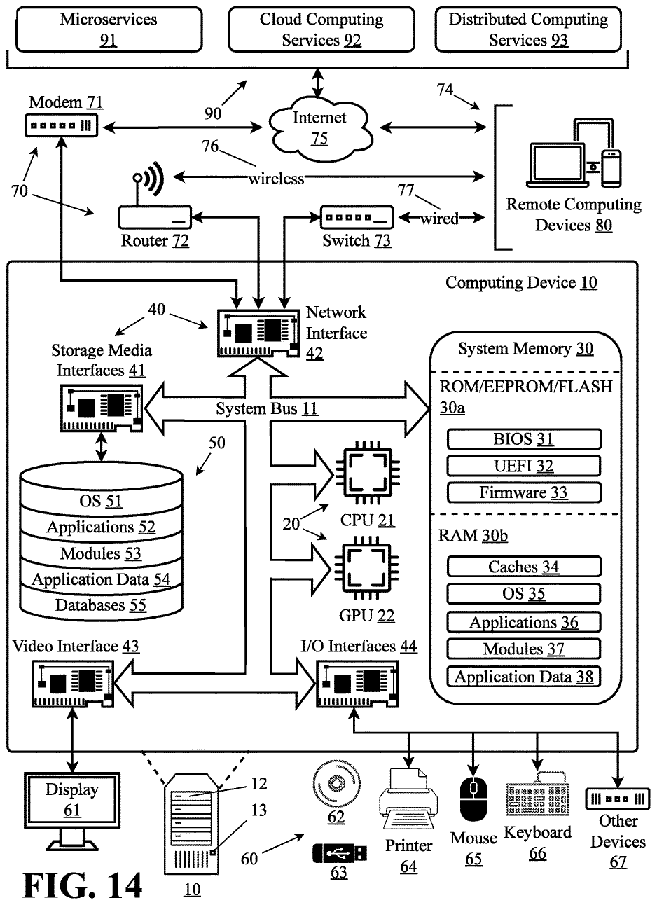

FIG. 14 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising at least one processor, a memory, and a plurality of programming instructions stored on a non-transitory computer-readable medium and configured to cause the at least one processor to:
bootstrap a persistent cognitive machine from an initial empty state by executing a differentiation sequence on a cognitive manifold, wherein the cognitive manifold in the initial empty state has no curvature, no sector differentiation, no consolidated knowledge reservoirs, and no boundary structures, the differentiation sequence comprising:
flooding the cognitive manifold with evidence to generate curvature on the cognitive manifold from the initial empty state;
separating the generated curvature into semantic curvature and epistemic curvature through rate separation driven by distinct dynamical laws governing each curvature type;
forming proto-reservoirs in regions of the cognitive manifold that receive locally consistent evidence through differential relaxation;
nucleating irreversible boundaries through a positive feedback process that concentrates barrier energy at a boundary between a proto-reservoir interior region and an exterior region, wherein each nucleated boundary constitutes an irreversible constitutive commitment of the persistent cognitive machine;
crystallizing routing channels that direct curvature flow through the nucleated boundaries into consolidated knowledge reservoirs; and
achieving constitutive closure in which a three-timescale hierarchy governing an active sector, a boundary sector, and an irreversible sector of the cognitive manifold has emerged from an initial undifferentiated timescale of the initial empty state.

2. The computer system of claim 1, wherein the cognitive manifold in the initial empty state has a flat metric, a trivial connection, and an almost-complex structure that is formally allocated but dynamically inert with all coupling coefficients equal to zero, and wherein all nodes of the cognitive manifold carry a sector tag set to undifferentiated and all curvature arrays are initialized to zero.

3. The computer system of claim 1, wherein the cognitive manifold is represented as a weighted graph data structure comprising a plurality of nodes and edges, each node storing a metric tensor, a connection coefficient set, a curvature cache, a Nijenhuis tensor component, a sector tag, and scheduling flags, and each edge storing a parallel transport matrix, a curvature flow rate, and a type-matching score.

4. The computer system of claim 1, wherein the semantic curvature is a tensor-valued quantity computed from a Riemannian metric tensor and its derivatives representing semantic content density, the epistemic curvature is a 2-form-valued quantity computed from a connection on the cognitive manifold representing belief-justification coherence, and the rate separation occurs because semantic compression is governed by Ricci-flow dynamics operating on a first timescale and epistemic relaxation is governed by Yang-Mills dynamics operating on a second timescale shorter than the first timescale.

5. The computer system of claim 4, wherein transition from flooding to separating is detected by monitoring spatial variance of a Nijenhuis tensor across the cognitive manifold, wherein low spatial variance indicates uniform coupling strain during flooding and increasing spatial variance indicates heterogeneous type separation during separating.

6. The computer system of claim 1, wherein forming proto-reservoirs comprises identifying connected components of nodes whose local curvature energy falls below a detection threshold and assigning each identified component a stability score computed from a ratio of its local curvature energy to a mean curvature energy of its surrounding neighborhood, and wherein proto-reservoirs whose stability scores do not exceed a survival threshold are dissolved by perturbation from inconsistent evidence.

7. The computer system of claim 1, wherein the differentiation sequence exhibits a fast-slow-fast temporal pattern in which flooding and separating proceed relatively rapidly, forming proto-reservoirs and nucleating irreversible boundaries are rate-limited by a nucleation bottleneck requiring cooperative evidence coherence across a spatial region of the cognitive manifold, and crystallizing routing channels and achieving constitutive closure proceed relatively rapidly once the nucleated boundaries are established.

8. The computer system of claim 1, wherein the positive feedback process operates as a self-sustaining cycle in which increased proto-reservoir efficiency lowers interior curvature, the lowered interior curvature steepens a curvature gradient at the proto-reservoir perimeter, the steepened gradient concentrates barrier energy at perimeter nodes, and the concentrated barrier energy activates admission-control logic that further lowers interior curvature by preferentially admitting type-compatible curvature and reflecting type-incompatible curvature.

9. The computer system of claim 1, wherein nucleating irreversible boundaries further comprises re-tagging perimeter nodes of each proto-reservoir from undifferentiated sector membership to boundary sector membership, initializing barrier energy accumulators at the re-tagged perimeter nodes, re-tagging interior nodes of each proto-reservoir from undifferentiated sector membership to irreversible sector membership, activating admission-control logic at the boundary nodes, and logging each boundary nucleation event to a commitment ledger with a monotonically increasing commitment counter.

10. The computer system of claim 1, wherein crystallizing routing channels comprises computing a type-matching score between incoming curvature from the active sector and an absorptive profile of each reservoir in the irreversible sector at each boundary node, and routing curvature preferentially to boundaries with higher type-matching scores, wherein three forms of misrouting comprising laundering, congestion, and starvation decrease as type-matching scores stabilize.

11. The computer system of claim 1, wherein the differentiation sequence is monitored by a genesis controller module configured to monitor phase-diagnostic signals comprising curvature density, spatial variance of a Nijenhuis tensor, proto-reservoir count and stability, curvature gradient magnitudes, timescale ratios, and an inflationary parameter, to transition between steps of the differentiation sequence when phase-specific diagnostic thresholds are met, to adjust scheduling parameters based on a current step, and to log irreversible commitment events to a commitment ledger, and wherein the genesis controller module is distinct from a steady-state health monitor that becomes active only after constitutive closure.

12. The computer system of claim 11, wherein constitutive closure is detected by monitoring an inflationary parameter defined as a ratio of a constitutive absorption rate to a product of an evidence flux rate and an activation footprint coefficient, wherein the inflationary parameter is zero when the persistent cognitive machine has no absorptive capacity, increases toward unity as constitutive structure forms during the differentiation sequence, and reaches unity at constitutive closure, and wherein the persistent cognitive machine transitions from a linear scaling regime in which active node count grows proportionally with cumulative evidence to a logarithmic scaling regime in which active node count grows logarithmically with cumulative evidence upon constitutive closure.

13. The computer system of claim 12, wherein growth of the active computational load during the differentiation sequence is governed by a balance equation in which rate of change of active node count equals external evidence flux rate scaled by an inflationary gap, and wherein during proto-reservoir formation, boundary nucleation, and routing crystallization an inflationary acceleration is positive such that the differentiation sequence terminates in finite time without an external shutdown mechanism.

14. The computer system of claim 1, wherein the three-timescale hierarchy comprises a perturbation timescale governing high-frequency local curvature injection events in the active sector, a consolidation timescale governing intermediate-rate curvature type restructuring and compression in the active sector, and a reservoir timescale governing low-frequency irreversible curvature transfer through the boundary sector into the irreversible sector, wherein the perturbation timescale is shorter than the consolidation timescale, which is shorter than the reservoir timescale, and wherein this ordering is enforced by a scheduling architecture that gates slower operations on completion and stability of faster operations.

15. The computer system of claim 1, wherein a total curvature energy of the cognitive manifold satisfies a conservation law such that in the absence of new evidence from the evidence source the total curvature energy is redistributed among the active sector, the boundary sector, and the irreversible sector but is neither created nor destroyed, and wherein the conservation law is enforced by maintaining running sums of curvature energy in each sector and verifying that total curvature energy changes only by the amount of externally injected curvature.

16. The computer system of claim 1, further configured to, after constitutive closure, detect genuinely novel evidence by identifying simultaneous consolidation convergence failure in a localized region of the cognitive manifold and a local Nijenhuis tensor spike at the region of convergence failure, and in response allocate a genesis bubble comprising an isolated region of the cognitive manifold that locally re-enters the differentiation sequence constrained by boundary conditions from surrounding mature structure.

17. The computer system of claim 16, wherein the genesis bubble is not merged with the cognitive manifold until a local inflationary parameter of the genesis bubble reaches an integration window, and wherein the boundary conditions from the surrounding mature structure provide type axis alignment targets, evidence coherence information from adjacent domains, and pre-existing routing infrastructure at the genesis bubble boundary.

18. The computer system of claim 16, wherein merging the genesis bubble with the cognitive manifold comprises constructing a merger interface at a codimension-one region between the genesis bubble and the surrounding mature structure, the merger interface acquiring type transduction capacity to convert between curvature type conventions of the genesis bubble and the surrounding mature structure, and wherein constitutive mismatch at the merger interface is resolved across five independent components comprising type mismatch, routing mismatch, reservoir mismatch, timescale mismatch, and structural time mismatch.

19. The computer system of claim 1, wherein the evidence source comprises one or more of data inputs, sensor feeds, language model outputs, and outputs from an agent colony comprising a plurality of specialized agents configured to perform domain-specific operations on cached reasoning patterns, and wherein the agent colony provides domain-specific structured evidence flux to the cognitive manifold during the differentiation sequence.

20. The computer system of claim 1, wherein evidence is supplied to the cognitive manifold in a deliberate sequence that presents coherent evidence clusters prior to inconsistent evidence, increasing local evidence coherence during proto-reservoir formation and reducing a critical evidence volume required to achieve constitutive closure.
